(19) United States
(12) Patent Application Publication
(10) Pub. No.: US 2026/0194654 A1
(43) Pub. Date: Jul. 9, 2026

(54) MEASURING UNIT, SYSTEM, AND METHOD

(71) Applicant: Ocado Innovation Limited, Hatfield (GB)

(72) Inventors: Michael NASH, Hatfield (GB); Morgan CLARKE, Hatfield (GB); David HOLT, Hatfield (GB)

(21) Appl. No.: 19/558,539

(22) Filed: Mar. 6, 2026

Related U.S. Application Data
(63) Continuation of application No. PCT/EP2024/075342, filed on Sep. 11, 2024.

(30) Foreign Application Priority Data
Sep. 11, 2023 (GB) 2313804.3

(51) Int. Cl. G01S 15/88; B65G 1/04; G01S 15/08

(52) U.S. Cl. CPC G01S 15/88; B65G 1/0464; G01S 15/08; B65G 2203/0275; B65G 2203/042

(57) ABSTRACT

Measuring units, load handling devices, storage and retrieval systems, and methods function to determine alignment of a grid framework structure in a storage and retrieval system. The grid framework structure includes a supporting framework structure upon which is mounted to a track system that supports remotely operated load handling devices for handling storage containers stacked in storage columns under the grid framework structure, and guides for guiding storage containers in a storage column when lifted or lowered by the load handling device. Related measuring units and load handling devices and storage and retrieval systems are disclosed. The method includes moving a measuring unit within a storage column in a vertical direction, guided by a set of guides. Each distance sensor is used to measure the distance between it and one guide, and the measured distance(s) are used to determine whether the set of guides is misaligned.

### RELATED APPLICATIONS

This application is a continuation of International Patent Applicant No. PCT/EP2024/075342, filed 11 Sep. 2024 and entitled “Measuring Unit, System, and Method,” which claims priority to United Kingdom Patent Application No. GB 2313804.3, filed 11 Sep. 2023 and entitled “Measuring Unit, System, and Method”; the entire contents of all of which applications are incorporated herein by reference.

### TECHNICAL FIELD

This disclosure relates to the field of determining alignment of a grid framework structure in a storage and retrieval systems, more specifically to a measuring unit engaged by a load handling device operative on a track system of a grid framework structure. The grid framework structure comprises a supporting framework structure upon which is mounted a track system that supports remotely operated load handling devices for handling storage containers stacked in the grid framework structure.

### BACKGROUND

Cubic storage and retrieval systems are well known. For example, WO2015185628 describes a storage and retrieval system in which stacks of storage containers are arranged within a grid framework structure. The storage containers are accessed from above by load handling devices operative on rails or tracks located on the top of the grid framework structure.

When a grid framework structure is assembled, the components must be aligned in order to ensure smooth motion of load handling devices on top of the track system; ideally the track system should be level, extending in a horizontal plane. Misalignment of tracks can prevent load handling devices from running smoothly, for example any step or vertical misalignment or gaps between adjacent track elements can cause the wheels of the load handling devices to bump up and down when traversing over the step or gap, in turn causing fatigue. In a worst-case scenario, misaligned tracks could cause a derailment or prevent the load handling devices from travelling at all.

Not only must the upright members supporting the track system be substantially vertical to ensure smooth running of load handling devices operative on the track system, but also the guides for guiding the movement of storage containers should be substantially vertical in order to ensure smooth lifting/lowering of the storage containers.

The alignment of the guides will affect the direction in which the storage containers are lifted into the correct position through a grid cell. If the guides or upright members deviate from the vertical, this will not only put a strain on the one or more load handling devices travelling on the grid framework structure since the track system may not be level, but also will cause the lifting tethers to sway to one side depending on the direction of the deviation. In a worst-case scenario, misalignment of the upright members or the guides may cause the grabber device to fail to engage with the storage container below.

The process of assembling, aligning, and checking the many different components when assembling a grid framework structure can be time-consuming and expensive.

Moreover, given the weight and the changeable forces to which the grid framework structure is continuously subjected to during its operation, the initially aligned grid framework structure may become misaligned over time, requiring the upright members and the guides to be periodically adjusted. This requires a user to identify the area of unevenness in the grid framework structure and to adjust accordingly. The time and effort to periodically inspect the alignment of the grid framework structure and to realign becomes a problem if the operation of grid framework structure is halted in order to carry out the inspection and any adjustments required.

Given that commissioning a grid framework structure takes a long time because of the need to check alignment of each element manually during assembly, and the need to check alignment again later if there is a problem, a means is needed to quickly and easily inspect the grid framework structure to determine whether components are correctly aligned and identify any problems.

### SUMMARY

This disclosure provides a measuring unit, load handling device, storage and retrieval system, and a method of determining alignment of a grid framework structure in a storage and retrieval system.

The grid framework structure comprises a supporting framework structure upon which is mounted a track system that supports remotely operated load handling devices for handling storage containers stacked in storage columns the grid framework structure, and a plurality of guides for guiding storage containers in a storage column when lifted or lowered by the load handling device.

In one aspect, a measuring unit is provided, comprising at least one distance sensor mounted to the measuring unit configured to measure the distance(s) between the sensor and a vertical surface of a guide.

In another aspect, a load handling device is provided, configured to lift and lower a measuring unit.

In another aspect, a storage and retrieval system is provided, comprising a grid framework structure, one or more load handling devices, and one or more measuring units.

In another aspect, a method of determining the alignment of a grid framework structure is provided. The method comprises moving a measuring unit within a storage column in a vertical direction, guided by a set of guides. Each of the at least one distance sensor is used to measure the distance between the distance sensor and one guide of the set of guides, and the measured distance(s) are used to determine whether the set of guides is misaligned.

A method of determining the alignment of a grid framework structure is provided, the grid framework structure comprising:
i) a track system comprising a plurality of tracks arranged in a grid pattern, configured to support one or more load handling devices thereupon;
ii) a supporting framework structure comprising a plurality of upright members for supporting the track system above the ground to create a plurality of storage columns for the storage of a plurality of storage containers in stacks such that a load handling devices operative on the track system is configured to lift a storage container through a grid cell from a stack below the track system; and
iii) a plurality of guides, each comprising one or more substantially vertical surfaces for guiding storage containers in a storage column between the guides when lifted or lowered in a vertical direction;
   the method comprising the steps of:
a) a load handling device lifting or lowering a measuring unit within a storage column in a vertical direction between a set of the plurality of guides, such that the measuring unit is guided by the set of guides, the measuring unit comprising a distance sensor mounted to the measuring unit;
b) measuring the distance between the distance sensor and one guide of the set of guides;
c) determining whether the guide is misaligned based on the measured distance.

The set of the plurality of guides within a storage column comprises one or more guides. For example, four guides can be provided, one at each of the four corners of a rectangular storage column, or two guides at diagonally opposite corners, or guides could be provided along one or more sides of the storage column rather than the corners, or there could be a single tubular guide through which the measuring unit is guided.

In some examples, the guides may be integral with the upright members. In some examples, the guides may be fitted to the upright members. In cases where the guides are integral with or attached to the upright members, misalignment in a guide can be indicative of misalignment in an upright member. In some examples, every node or intersection of the track system may be supported by an upright member with attached or integral guides, such that each storage column has a guide at each of the four corners of the storage column or grid cell. In other cases, alternate nodes of the track system can be supported by upright members, such that each storage column has two guides at diagonally opposed corners of the grid cell. Other configurations are possible.

In other examples, separate guides may be provided that are not load bearing like the upright members. In this case, as above, each storage column can be provided with a guide at all four corners of the grid cell, or at two diagonally opposed corners. Other configurations are possible.

The measuring unit may comprise a plurality of distance sensors mounted to the measuring unit, and step b) may comprise, for each of the plurality of distance sensors, measuring the distance between that distance sensor and a respective guide of the set of guides, and step c) may comprise determining whether the set of guides are misaligned based on the plurality of measured distances. An advantage of using multiple distance sensors is that more measurements can be taken, so the distance between guides can easily be calculated and misalignment determined more easily. Distance sensors can measure the distances between the sensors and different points on the same guide, or the distances between the distance sensors and different guides, depending on the arrangement of distance sensors on the measuring unit, and on the number and arrangement of the set of guides in the storage column.

Step b) may comprise measuring a plurality of distances between the distance sensor and one or more guides of the set of guides, and step c) may comprise determining whether the set of guides are misaligned based on the plurality of measured distances. In this example a single distance sensor can measure multiple distances, between the distance sensor and multiple guides or multiple points on the same guide.

In examples where multiple distance sensors are mounted to the measuring unit, step b) may comprise, for each distance sensor, measuring a plurality of distances between the distance sensor and one or more guides of the set of guides, and step c) may comprise determining whether the set of guides are misaligned based on the plurality of measured distances. In this example, one distance sensor measures more than one distance. For example, four wide-angle distance sensors may each be mounted to a respective corner of the four corners of the measuring unit, and each distance sensor may measure two distances to the two perpendicular guiding plates of the guide located at that corner of the storage column.

If the method determines that one or more guides of the set of guides is misaligned, the misalignment can be corrected. For example, fastenings that connect guides to upright members and/or that connect upright members to horizontal members can be loosened. This permits some play in the positioning and alignment of the grid members, so small adjustments in position can be made and the fastenings then tightened to secure the grid components in their aligned positions.

Step c) may comprise determining a misalignment value from the measured distance(s), comparing the misalignment value to a predetermined threshold misalignment value, and determining that the guides are misaligned if the misalignment value is greater than the predetermined threshold misalignment value.

The method may further comprise the step of:

d) repeating steps a) to c) for another storage column in the grid framework structure.

The method may further comprise the step of:

e) determining a map of the misalignment value as a function of location in the grid framework structure.

The map of misalignment value as a function of location in the grid framework structure may be a three-dimensional map, storing the horizontal position or X, Y co-ordinates of the storage column/grid cell, and the depth down the storage column (Z co-ordinate). The depth could, for example, be defined as the distance downwards from the track system, or upwards from the floor on which the grid framework structure stands, or the number of storage container positions in the storage column (e.g. Z=1 is the top position immediately below the track system, Z=2 is the position below that, etc.).

The process of determining alignment can be carried out on a subsection of the grid framework structure or on the entire grid framework structure. For example, when a grid framework structure is first constructed, a full check of alignment of the whole grid framework structure may be necessary. Periodic maintenance checks of the whole or parts of the grid framework structure may be carried out. Specific parts of the grid framework structure may be checked in response to any issues with load handling devices operating on those areas.

The method may be carried out by a single load handling device methodically checking every storage column, which has the advantage that the load handling device can be calibrated and will have consistent offsets when measuring distances. Alternatively, a fleet of load handling devices can be used to check storage columns simultaneously in order to complete a check in a faster time.

Lifting or lowering the measuring unit in step a) may comprise the measuring unit being engaged by a container-engaging assembly of the load handling device. An advantage is that a standard load handling device may be used, with no need to modify or adapt the load handling device to engage a measuring unit.

The method may further comprise the step of calibrating the load handling device before step a). The step of calibrating the load handling device may comprise manually measuring the measuring unit, then using the measuring unit on a calibration jig (known to be square/rectilinear) in order to acquire reference measurements to use as a point of comparison for measurements taken in the storage columns.

A measuring unit is provided, configured to be lifted and lowered by a load handling device, the measuring unit comprising at least one distance sensor mounted to the measuring unit configured to measure the distance(s) between the sensor and a vertical surface of a guide. The sensor may be positioned in such a way as to be directed horizontally, and measure the horizontal distance between the sensor and the vertical surface of the nearest guide.

The measuring unit may further comprise an outer casing configured to be received within the load handling device. The outer casing may comprise one or more engagement features configured to be engaged by the load handling device. The measuring unit can be received within the container-receiving space of the load handing device and moved on the track system to a different storage column in the same way as a storage container. The measuring unit can be lowered and lifted within a storage column in the same way as a storage container. An advantage of this arrangement is that a standard load handling device can be used to carry out the tasks of moving the measuring unit (both between storage columns and within a storage column), with no need for a specialised load handling device to be adapted for this purpose.

The measuring unit may be substantially cuboid in shape and comprise a base and four side walls. An advantage of this feature is that the measuring unit fits neatly within the rectangular grid cell of a storage column, and can be guided by the set of guides in that storage column, for example the corners of the measuring unit can be guided by guides located at the corners of the storage column.

The at least one distance sensor may comprise eight distance sensors, two of the eight distance sensors positioned on each of the four side walls of the measuring unit. The distance sensors may be located near to the edges of the side walls. This arrangement is suitable for a storage column in which four guides are located at the four corners, each guide comprising two perpendicular plates which guide the corners of the measuring unit. This arrangement has the advantage that the distances between the sensors and all four of the guides is measured in both the x and y directions, in order to give a more complete assessment of misalignment.

Adjacent distance sensors may be vertically offset. This feature has the advantage of avoiding interference between adjacent distance sensors, i.e. the receiver of one distance sensor will not detect the signal from an adjacent distance sensor.

The at least one distance sensor may comprise an ultrasonic sensor.

The at least one distance sensor may comprise two wide-angle distance sensors positioned on diagonally opposing corners of the measuring unit. An advantage of this arrangement is that fewer sensors are needed, resulting in a reduced cost, complexity, and part count of the measuring unit. This arrangement may be suitable for a storage column in which two guides are positioned at diagonally opposing corners of the storage column, such that each of the two wide-angle distance sensors can measure the distances to both plates of the respective guide.

The measuring unit may further comprise a first vertical distance sensor directed vertically upwards in use, configured to measure the vertical distance between the first vertical distance sensor and the underside of the load handling device. The measuring unit may further comprise a second vertical distance sensor directed vertically downwards in use, configured to measure the vertical distance between the second vertical distance sensor and the ground. The term “vertical distance sensor” here should be construed to mean a distance sensor for measuring vertical distance when the measuring unit is within a storage column. Either the first vertical distance sensor or the second vertical distance sensor, or both, or neither, may be present. An advantage of the measuring unit comprising a first and/or second vertical distance sensor is that the height of the measuring unit in the storage column can be determined, which is especially useful in cases where the measuring unit is used to create a misalignment map.

The first and/or second vertical distance sensor may comprise a laser sensor. In general, laser sensors are appropriate for measuring larger distances (e.g. the distance between the measuring unit and the floor of the building or underside of the load handling device, e.g. metres or tens of metres), whereas ultrasonic sensors are appropriate for measuring smaller distances (e.g. the distance between the distance sensors and the guides, e.g. centimetres).

The measuring unit may further comprise one or more tilt sensors for measuring the inclination of the measuring unit from the horizontal. The tilt sensors determine whether the measuring unit is level. Two tilt sensors may be provided, one to measure tilt in the x direction, and one to measure tilt in the y direction.

The measuring unit may further comprise one or more vibration sensors for measuring vibrations of the grid framework structure. The vibration sensors may be triaxial vibration sensors. Fatigue affects the lifetime of components of the grid framework structure.

The measuring unit may further comprise one or more additional sensors for measuring an atmospheric condition. The one or more additional sensors comprise one or more of a temperature sensor, a humidity sensor, a pressure sensor, or a light sensor. The one or more additional sensors are useful in examples where environmental control of the storage system is paramount, for example food storage.

Alternatively or additionally, the measuring unit may further comprise one or more accelerometers.

The measuring unit may further comprise a power source for providing power to the one or more distance sensors. The power source can also power any other electronic components on the measuring device. In cases where the measuring unit also comprises other sensors (e.g. vibration sensors, vertical distance sensors, tilt sensors, or additional sensors for measuring an atmospheric condition, as described above), the power source may also provide power to the other sensors. Any appropriate power source can be used, for example a rechargeable battery. An advantage of the measuring unit having its own power source is that the measuring unit can be self-contained and does not require power form an external source.

The measuring unit may further comprise a power connector configured to receive power from the load handling device in order to provide power to the one or more distance sensors, when the measuring unit is engaged by the load handling device. The power connector can also power any other sensors or electronic components on the measuring device. An advantage of the load handling device providing power to the measuring unit is that the measuring unit can be used continuously without the need to pause operations in order to recharge the power source.

The measuring unit may further comprise a data logger for storing data from the one or more distance sensors. In cases where the measuring unit also comprises other sensors (e.g. vibration sensors, vertical distance sensors, tilt sensors, or additional sensors for measuring an atmospheric condition, as described above), the data logger may also store data from the other sensors.

The measuring unit may further comprise a processor for processing the data from the one or more distance sensors.

The measuring unit may further comprise a data connector configured to transmit data from the one or more distance sensors to the load handling device, when the measuring unit is engaged by the load handling device.

A load handling device is provided for lifting storage containers stacked in a grid framework structure, the load handling device being configured to lift and lower a measuring unit as defined herein.

The load handling device may comprise a container-engaging assembly configured to engage with the measuring unit. An advantage of this feature is that the load handling device can engage with the measuring unit in exactly the same way as with a storage container, so no modification to the load handling device is needed in order to be used to move the measuring unit.

The load handling device may comprise a container-engaging assembly, wherein the container-engaging assembly is the measuring unit.

A storage and retrieval system is provided, comprising:
a) a grid framework structure configured to support one or more load handling devices thereupon, the grid framework structure comprising:
i) a track system comprising a plurality of tracks arranged in a grid pattern, configured to support one or more load handling devices thereupon;
ii) a supporting framework structure comprising a plurality of upright members for supporting the track system above the ground to create a storage space for the storage of a plurality of storage containers in stacks such that, in use, a load handling devices operative on the track system is configured to lift a storage container through a grid cell from a stack below the track system;
iii) a plurality of guides, each of the plurality of guides comprising one or more vertical surfaces for guiding storage containers in a storage column between the upright members when lifted or lowered in a vertical direction;
b) one or more load handling devices as defined herein; and
c) one or more measuring units as defined herein.

Each of the one or measuring units may have substantially the same footprint as the storage containers. An advantage of the measuring unit having the same footprint as a storage container is that the outer corners of the measuring unit can engage with and be guided by the guides in the same way as a storage container. This ensures that the measuring unit can be lifted and lowered in a smooth and stable fashion.

Each of the one or more measuring units may have substantially the same external dimensions as the storage containers.

The measuring unit may further comprise a power connector configured to receive power from a corresponding power connector on the container-engaging assembly of the load handling device, when the measuring unit is engaged by the container-engaging assembly.

The measuring unit may further comprise a data connector configured to transmit data to a corresponding data connector on the container-engaging assembly of the load handling device, when the measuring unit is engaged by the container-engaging assembly.

### BRIEF DESCRIPTION OF FIGURES

Further features and aspects will be apparent from the following detailed description of an illustrative embodiment made with reference to the drawings.

FIG. 1 schematically illustrates a grid framework structure and storage containers.

FIG. 2 schematically illustrates track on top of the grid framework structure illustrated in FIG. 1.

FIG. 3 schematically illustrates load handling devices on top of the grid framework structure illustrated in FIG. 1.

FIG. 4 schematically illustrates a single load handling device with container-lifting means in a lowered configuration.

FIG. 5 includes views (a) and (b), which schematically illustrate cutaway views of a single load handling device with container-lifting means in a raised configuration, view (a); and a lowered configuration, view (b).

FIG. 6 is a perspective view of an example of a known container-lifting means.

FIG. 7 is a perspective side view of a known container-engaging assembly.

FIG. 8 is a perspective bottom view of a known container-engaging assembly.

FIG. 9 is a schematic illustration of a storage column with four upright members.

FIG. 10 is a schematic representation of cross-sectional top-down view of the arrangement of the upright members in the grid framework structure.

FIG. 11 includes views (a)-(c), which schematically illustrate an arrangement of guides: view (a) is a top view of a grid cell; view (b) is a side view of the guide attached to an upright member, and view (c) is a side view of a grid cell in a grid framework structure.

FIG. 12 includes views (a)-(b), which illustrate a guide support for connecting two guides to a connector, in exploded view in view (a), and assembled view in view (b).

FIG. 13 includes views (a)-(b), which illustrate a guide support for connecting four guides to a connector, in exploded view (a), and assembled view (b).

FIG. 14 includes views (a)-(b), which schematically illustrate two guides and an upright I-beam in exploded view (a), and assembled view (b).

FIG. 15 is a perspective view illustrating the arrangement of the upright members supporting the track system.

FIG. 16 is a schematic diagram illustrating a measuring unit, distance sensors, and a guide.

FIG. 17 is a schematic perspective view of a measuring unit.

FIG. 18 includes views (a)-(b), of which (a) is an exploded schematic perspective view and (b) is an assembled schematic perspective view of a vertical frame member of a measuring unit, two brackets, and two distance sensors.

FIG. 19 schematically illustrates a top view of a measuring unit with eight distance sensors, inside a storage column.

FIG. 20 schematically illustrates a top view of a measuring unit which is skewed relative to the storage column.

FIG. 21 is a flowchart illustrating a method of determining misalignment of a grid framework structure.

### DETAILED DESCRIPTION

The following embodiments represent the applicant's preferred examples of how to implement the disclosure, but they are not necessarily the only examples of how that could be achieved.

### Grid Framework Structure

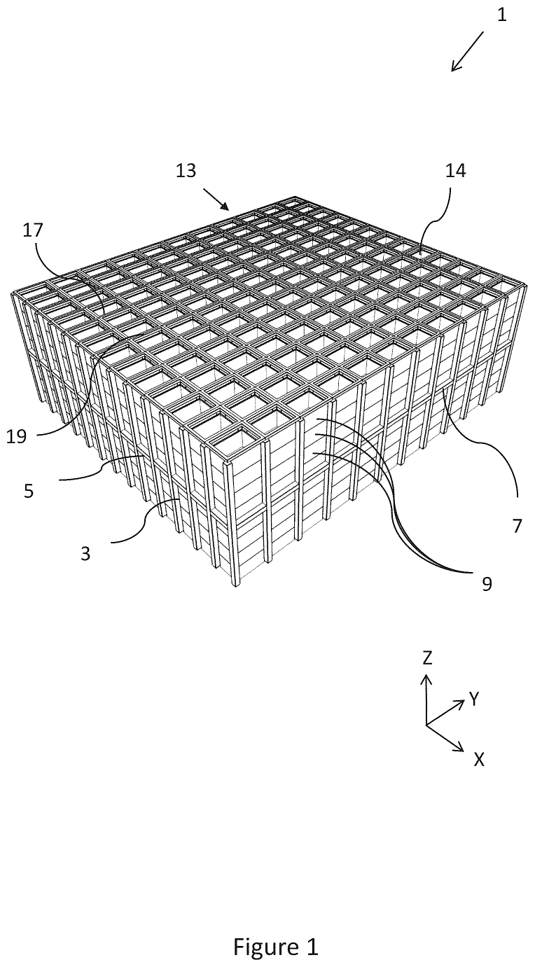

FIG. 1 illustrates a grid framework structure 1 comprising a supporting framework structure 2 supporting a track structure 13. The supporting framework structure 2 can take any suitable form. In the specific example illustrated in FIG. 1, the supporting framework structure 2 comprises a plurality of upright members 3 and horizontal members 5, 7 which are supported by the upright members 3. Upright members 3 may also be referred to as upright members 3. The horizontal members 5 extend parallel to one another and the illustrated x-axis. The horizontal members 7 extend parallel to one another and the illustrated y-axis, and transversely to the horizontal members 5. The upright members 3 extend parallel to one another and the illustrated z-axis, and transversely to the horizontal members 5, 7. The horizontal members 5, 7 form a grid pattern defining a plurality of grid cells. In the illustrated example, storage containers 9 are arranged in stacks 11 beneath the grid cells defined by the grid pattern, one stack 11 of storage containers 9 per grid cell.

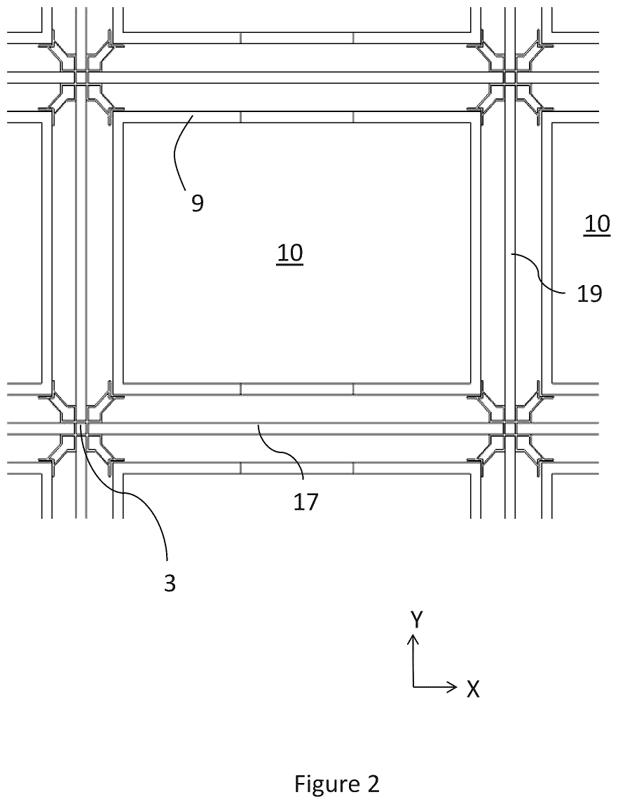

FIG. 2 shows a large-scale plan view of a section of track structure 13 forming part of the grid framework structure 1 illustrated in and located on top of the horizontal members 5, 7 of the grid framework structure 1 illustrated in FIG. 1. The track structure 13 may be provided by the horizontal members 5, 7 themselves (e.g. formed in or on the surfaces of the horizontal members 5, 7) or by one or more additional components mounted on top of the horizontal members 5, 7. The illustrated track structure 13 comprises x-direction tracks 17 and γ-direction tracks 19, i.e. a first set of tracks 17 which extend in the x-direction and a second set of tracks 19 which extend in the y-direction, transverse to the tracks 17 in the first set of tracks 17. The tracks 17, 19 define apertures 15 at the centres of the grid cells. The apertures 15 are sized to allow storage containers 9 located beneath the grid cells to be lifted and lowered through the apertures 15. The x-direction tracks 17 are provided in pairs separated by channels 21, and the y-direction tracks 19 are provided in pairs separated by channels 23. Other arrangements of track structure may also be possible.

As an alternative to the supporting framework structure 2 as described with reference to FIG. 1, in other examples the support framework structure comprises a plurality of prefabricated modular panels arranged in a grid pattern, the detail of which is described briefly below and fully in the PCT application, WO2022034195A1, in the name of Ocado Innovation Ltd, and incorporated herein by reference. This grid framework structure 1 described in WO2022034195A1 addresses the problem of time and cost to assemble by providing a supporting framework structure 2 comprising a plurality of prefabricated modular panels arranged in a three-dimensional (3D) grid pattern to define a plurality of grid cells. Each of the grid cells of the supporting framework structure 2 is sized to support two or more grid cells of the track system 13. The grid framework structure 1 is formed from fewer structural components yet still maintains the same structural integrity as the typical “stick-built” grid framework structure 1 described above, and is much faster and cheaper to build.

Any appropriate supporting framework structure 2 comprising upright members 3 can be used with the measuring unit, system, and method of this disclosure.

To provide the necessary structural support, the horizontal and upright members of the grid framework structure may be I-beams or other cross-sectional shapes that provide the necessary structural support for the grid framework structure to support one or more load handling devices operative on the track system. A cap plate can be used to interconnect the grid members together at the nodes or at the intersections. The horizontal grid members may comprise a track support and track mounted to the track support. The track support can be integrated into or form part of the horizontal grid members to allow a track to be mounted to the track support. For example, in the case where the cross-sectional profile of the track support is an I-beam, the underside of the track may be profiled to cradle a beam flange of the I-beam and engage with the track support in a snap fit arrangement. Alternatively, the track can be integrated into the track support such that the horizontal grid member comprises both the track support and the track.

### Load Handling Device

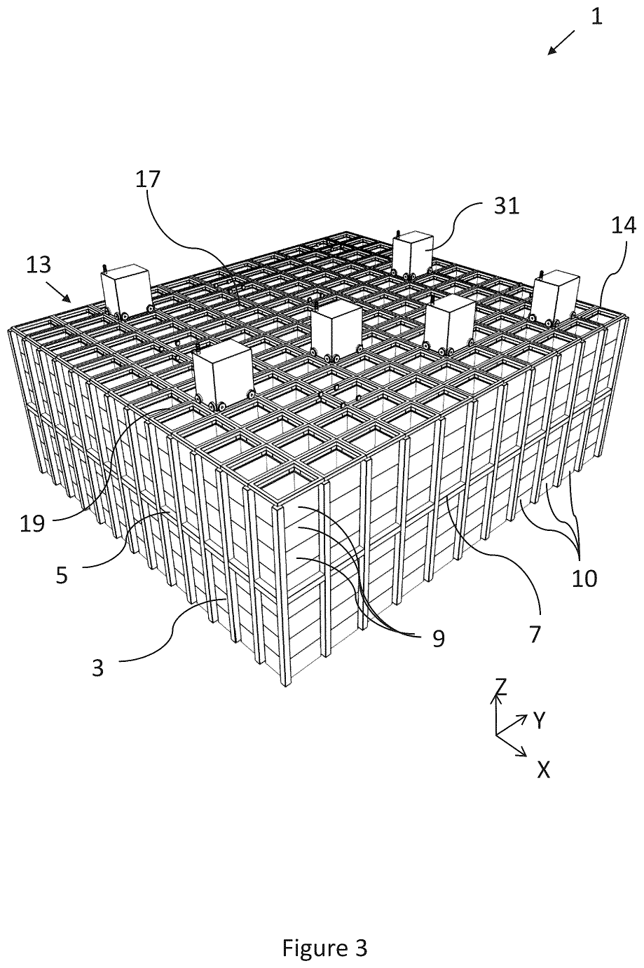

FIG. 3 shows a plurality of load handling devices 31 moving on top of the grid framework structure 1 illustrated in FIG. 1. The load handling devices 31, which may also be referred to as robots 31 or bots 31, are provided with sets of wheels to engage with corresponding x- or y-direction tracks 17, 19 to enable the load handling devices 31 to travel across the track structure 13 and reach specific grid cells. The illustrated pairs of tracks 17, 19 separated by channels 21, 23 allow load handling devices 31 to occupy (or pass one another on) neighbouring grid cells without colliding with one another.

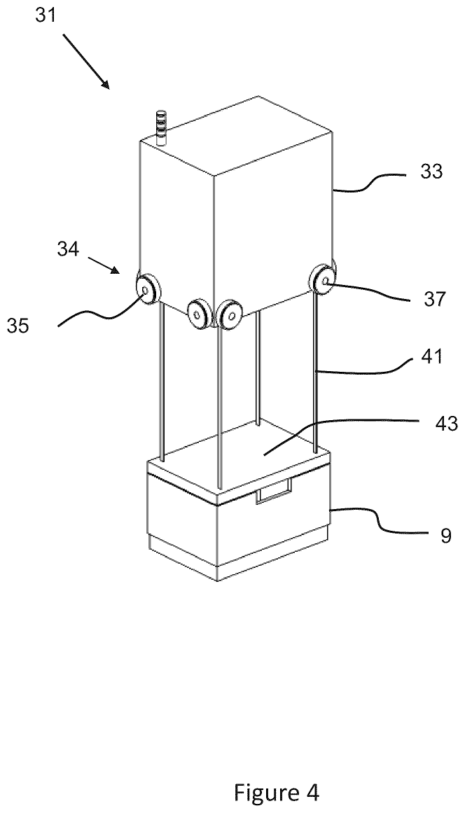

As illustrated in detail in FIG. 4, a load handling device 31 comprises a body 33 in or on which are mounted one or more components which enable the load handling device 31 to perform its intended functions. These functions may include moving across the grid framework structure 1 on the track structure 13 and raising or lowering storage containers 9 (e.g. from or to stacks 11) so that the load handling device 31 can retrieve or deposit storage containers 9 in specific locations defined by the grid pattern.

The load handling device 31 comprises a wheel assembly 34. The embodiment of the load handling device 31 illustrated in FIG. 4 comprises first and second sets of wheels 35, 37 which are mounted on the body 33 of the load handling device 31 and enable the load handling device 31 to move in the x- and y-directions along the tracks 17 and 19, respectively. In particular, two wheels 35 are provided on the shorter side of the load handling device 31 visible in FIG. 4, and a further two wheels 35 are provided on the opposite shorter side of the load handling device 31 (side and further two wheels 35 not visible in FIG. 4). The wheels 35 engage with tracks 17 and are rotatably mounted on the body 33 of the load handling device 31 to allow the load handling device 31 to move along the tracks 17. Analogously, two wheels 37 are provided on the longer side of the bot 31 visible in FIG. 4, and a further two wheels 37 are provided on the opposite longer side of the load handling device 31 (side and further two wheels 37 not visible in FIG. 4). The wheels 37 engage with tracks 19 and are rotatably mounted on the body 33 of the load handling device 31 to allow the load handling device 31 to move along the tracks 19.

The wheel assembly 34 of the load handing device 31 may be driven by a driving mechanism 38. The driving mechanism 38 may comprise one or more motors.

The load handling device 31 also comprises container-lifting means 39 configured to raise and lower storage containers 9. The illustrated container-lifting means 39 comprises four tapes or reels 41 which are connected at their lower ends to a container-engaging assembly 43. The container-engaging assembly 43 comprises engaging means (which may, for example, be provided at the corners of the assembly 43, in the vicinity of the tapes 41) configured to engage with features of the storage containers 9. For instance, the storage containers 9 may be provided with one or more apertures in their upper sides with which the engaging means can engage. Alternatively or additionally, the engaging means may be configured to hook under the rims or lips of the storage containers 9, and/or to clamp or grasp the storage containers 9. The tapes 41 may be wound up or down to raise or lower the container-engaging assembly, as required. The container-lifting means 39 may be driven by a driving mechanism 38. The winding up or down of the tapes 41 of the container-lifting means 39 may be effected or controlled by the driving mechanism 38, which may comprise one or more motors or other means. The same driving mechanism 38 can be used to drive both the wheel assembly 34 and the container-lifting means 39, or separate driving mechanisms may be used for driving the wheel assembly and for driving the container-lifting means.

As can be seen in Figure, views (a)-(b), the body 33 of the illustrated load handling device 31 has an upper portion 45 and a lower portion 47. The upper portion 45 is configured to house one or more operation components (not shown). The lower portion 47 is arranged beneath the upper portion 45. The lower portion 47 comprises a container-receiving space 49 or cavity for accommodating at least part of a storage container 9 that has been raised by the container-lifting means 39. The container-receiving space 49 is sized such that enough of a storage container 9 can fit inside the cavity to enable the load handling device 31 to move across the track structure 13 on top of grid framework structure 1 without the underside of the storage container 9 catching on the track structure 13 or another part of the grid framework structure 1. When the load handling device 31 has reached its intended destination, the container-lifting means 39 controls the tapes 41 to lower the container-engaging assembly 43 and the corresponding storage container 9 out of the container-receiving space 49 in the lower portion 47 and into the intended position. The intended position may be a stack 11 of storage containers 9 or an egress point of the grid framework structure 1 (or an ingress point of the grid framework structure 1 if the load handling device 31 has moved to collect a storage container 9 for grid framework in the grid framework structure 1). Although in the illustrated example the upper and lower portions 45, 47 are separated by a physical divider, in other embodiments, the upper and lower portions 45, 47 may not be physically divided by a specific component or part of the body 33 of the load handling device 31.

In some embodiments, the container-receiving space 49 of the load handling device 31 may not be within the body 33 of the bot 31. For example, in some embodiments, the container-receiving space 49 may be adjacent to the body 33 of the load handling device 31, e.g. in a cantilever arrangement with the weight of the body 33 of the load handling device 31 counterbalancing the weight of the storage container to be lifted. In such embodiments, a frame or arms of the container-lifting means 39 may protrude horizontally from the body 33 of the load handling device 31, and the tapes/reels 41 may be arranged at respective locations on the protruding frame/arms and configured to be raised and lowered from those locations to raise and lower a storage container into the container-receiving space 49 adjacent to the body 33. The height at which the frame/arms is/are mounted on and protrude(s) from the body 33 of the load handling device 31 may be chosen to provide a desired effect. For example, it may be preferable for the frame/arms to protrude at a high level on the body 33 of the load handling device 31 to allow a larger storage container (or a plurality of storage containers) to be raised into the container-receiving space beneath the frame/arms. Alternatively, the frame/arms may be arranged to protrude lower down the body 33 (but still high enough to accommodate at least one storage container between the frame/arms and the track structure 13) to keep the centre of mass of the load handling device 31 lower when the load handling device 31 is loaded with a storage container.

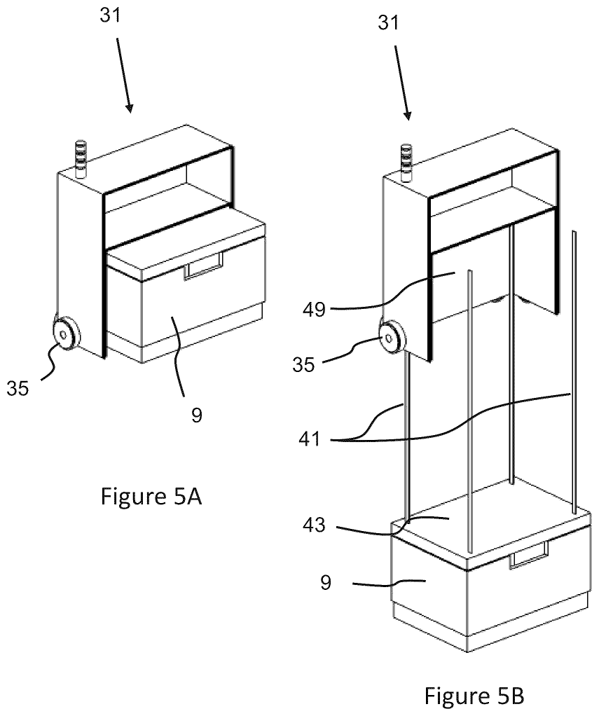

The specific example of a load handling device illustrated in FIGS. 4 and 5 shows the load handling device 31 with a body 33 that is substantially box-shaped with four sidewalls and a top wall, with the components of the load handling device 31 housed within the body 33. In other examples the body 33 may comprise an open frame or skeleton structure, within or upon which components of the load handling device 31 are supported.

To enable the load handling device 31 to move on the different wheels 35, 37 in the first and second directions, the load handling device 31 includes a wheel-positioning mechanism for selectively engaging either the first set of wheels 35 with the first set of tracks 17 or the second set of wheels 37 with the second set of tracks 19. The wheel-positioning mechanism is configured to raise and lower the first set of wheels 35 and/or the second set of wheels 37 relative to the body 33, thereby enabling the load-handling device 31 to selectively move in either the first direction or the second direction across the tracks 17, 19 of the grid framework structure 1.

The wheel-positioning mechanism may include one or more linear actuators, rotary components or other means for raising and lowering at least one set of wheels 35, 37 relative to the body 33 of the load handling device 31 to bring the at least one set of wheels 35, 37 out of and into contact with the tracks 17, 19. In some examples, only one set of wheels is configured to be raised and lowered, and the act of lowering the one set of wheels may effectively lift the other set of wheels clear of the corresponding tracks while the act of raising the one set of wheels may effectively lower the other set of wheels into contact with the corresponding tracks. In other examples, both sets of wheels may be raised and lowered, advantageously meaning that the body 33 of the load handling device 31 stays substantially at the same height and therefore the weight of the body 33 and the components mounted thereon does not need to be lifted and lowered by the wheel-positioning mechanism.

The driving mechanism(s) 38 used to drive the wheel assembly 34 and the container-lifting means 39 can be powered by a main rechargeable power source 53.

In some examples, the grid framework structure 1 may comprise one or more port columns or vertical chutes to facilitate the entry or removal of storage containers from the grid framework structure. A port column occupies one grid cell 14, bounded at the four corners by four of the upright members 3 of the grid framework structure 1. Vertical guides may be provided to guide the storage container 9 in a vertical direction. To remove a storage container 9 from the grid framework structure 1, a load handling device 31 carrying a storage container 9 in its container-receiving space 49 travels to the grid cell 14 at the top of the port column and lowers the storage container 9 down until the storage container 9 reaches the bottom of the port column. The container-engaging assembly 43 of the load handling device 31 then disengages from the storage container 9 and is lifted back into the body 33 of the load handling device. The storage container 9 at the bottom of the port column can then be removed, for example by a conveyor belt or vehicle or human operative.

To bring a storage container 9 into the grid framework structure 1, the same operation is used in reverse. The storage container 9 is brought to the bottom of a port column (for example, by a conveyor belt or vehicle or human operative). A load handling device 31 travels to the grid cell at the top of the port column and lowers its container-engaging assembly 43 down the port column. The container-engaging assembly engages with the storage container, and the container-lifting means 39 lifts the storage container 9 up through the port column and into the container-receiving space 49 of the load handling device 31. The load handling device then travels on the track structure to take the storage container to its destination location in the grid framework structure.

### Container-Lifting Means

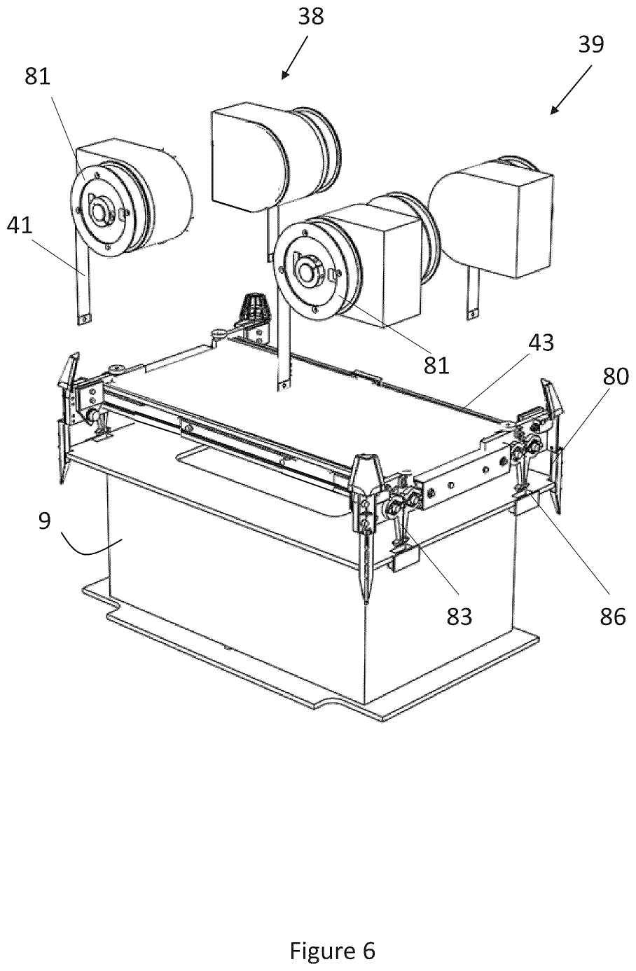

FIG. 6 shows a container-lifting means 39 known in the art, which comprises a container-engaging assembly 43, otherwise known as a grabber device, for releasably connecting to a storage container 9 below, and a driving mechanism 38 to raise and lower the container-engaging assembly 43. The driving mechanism 38 can be the same driving mechanism used to drive both the wheel assembly 34 and the container-lifting means 39, or separate driving mechanisms may be used.

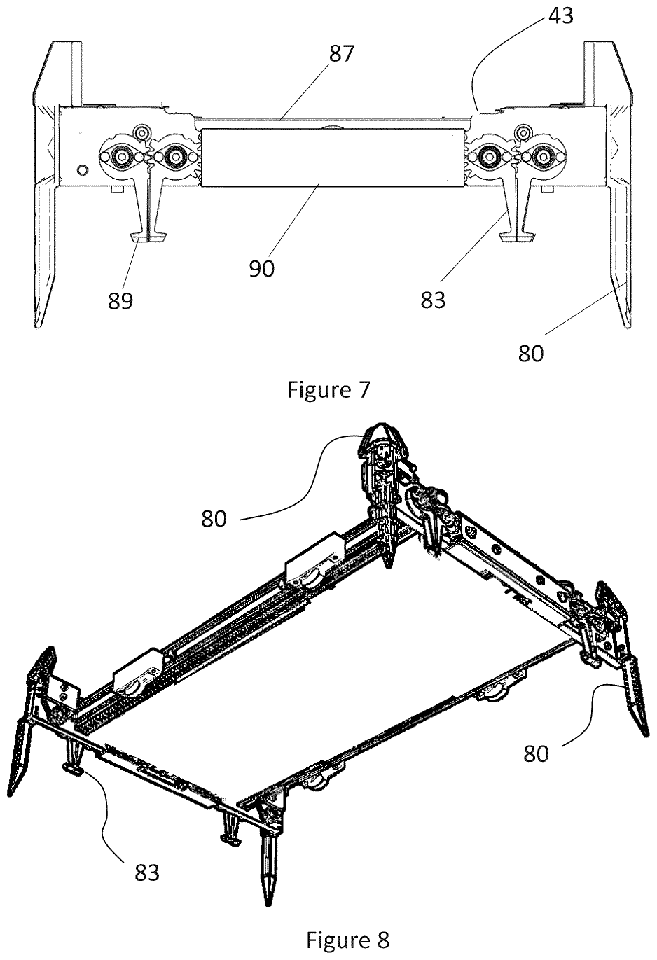

To raise and lower the container-engaging assembly 43, the driving mechanism 38 known in the art comprises a set of lifting tapes or bands 41 extending in a vertical direction between the container-engaging assembly 43 and the driving mechanism 38. For maximum stability and load capacity, commonly four lifting tapes 41 wound on respective spools 81 are shown extending between the driving mechanism 38 and at each corner of the container-engaging assembly 43. In an exemplary embodiment, the container-engaging assembly 43 is formed as a frame having four corner sections, a top side 87 and a bottom side 90 (see FIG. 7). To grab a storage container 9, the container-engaging assembly 43 comprises four locating pins or guide pins 80 nearby or at each corner of the container-engaging assembly 43 which mate with corresponding cut outs or holes (not shown) formed at four corners of the storage container 9. Four gripper elements 83 arranged at the bottom side of the container-engaging assembly 43 to engage with the rim of the storage container 9 (see FIGS. 7 and 8). The locating pins 80 help to properly align the gripper elements 83 with corresponding holes or openings in the rim of the storage container 9. In the particular embodiment shown in FIG. 7, each of the gripper elements 83 comprises a pair of wings that are collapsible so as to be receivable in corresponding holes or openings 86 in the rim of the storage container 9 (see FIG. 6) and an open or enlarged configuration having a size greater than the holes 86 in the rim of the storage container 9 in at least one dimension so as to lock onto the storage container (see FIG. 6). The wings are actuated into the open and closed configuration by a suitable actuating mechanism coupled to a drive gear, but other actuating mechanisms for actuating the gripper elements known in the art are applicable. In the specific example shown in FIG. 7, the head of at least one of the wings comprises a plurality of teeth that mesh with the drive gear such that when the gripper elements 83 are actuated by the actuating mechanism, rotation of the drive gear causes the pair of wings to rotate from a closed or collapsed configuration to an open enlarged configuration (FIGS. 7 and 8). When in the collapsed or closed configuration, the gripper elements 83 are sized to be receivable in corresponding holes 86 in the rim of the storage container 9 as shown in FIG. 6. The foot of each of the pair of wings comprises a stop 89, e.g. a boss, such that when received in a corresponding hole 86 in the rim of the storage container 9, the stop 89 engages with an underside of the rim when in an enlarged open configuration to lock onto the storage container when the container-engaging assembly 43 is winched upwards towards the container-receiving space 49 of the load handling device 31.

### Guides

The grid framework structure further comprises vertically extending guides, each guide defining a corner of one of the plurality of storage columns. For example, the guides may comprise two perpendicular elongated plates connected along the long edge of the plates. The purpose of the guides is to guide a corner of a storage container in a vertical direction within a storage column when the storage container is lifted or lowered by the load handling device operative on the track system. Guides help to constrain the storage container to move in a vertical direction, reducing the likelihood of the storage container swinging or bumping into upright members while being lifted or lowered.

The guides may be integral with the upright members, or a separate part attached to the upright members, or in some examples guides may be provided that are not load bearing.

In some examples, each of the upright members 3 is tubular. In transverse cross-section in the horizontal plane, each of the upright members comprises a hollow centre section (typically a box section) with one or more guides mounted to or formed at the corners of the hollow centre section that extends along the longitudinal length of the upright member for guiding the movement of the storage containers along the upright member.

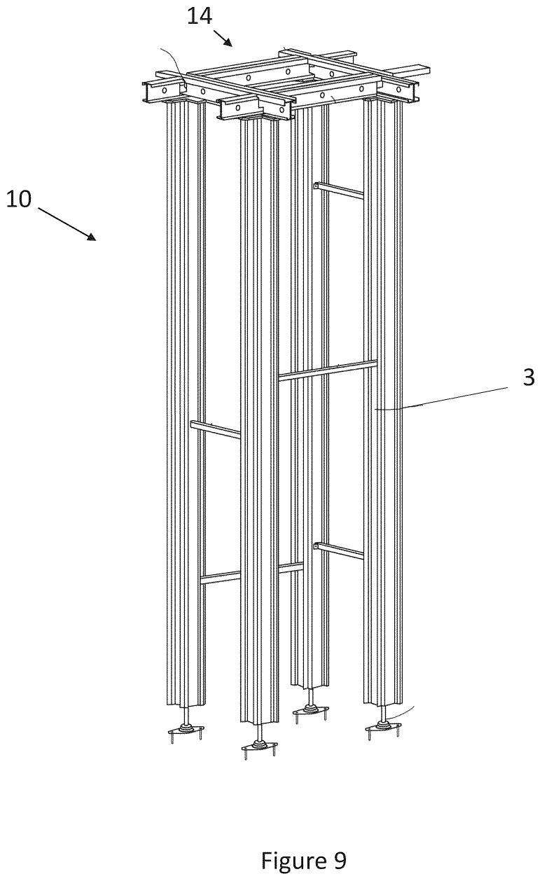

As shown in FIG. 9, the upright members 3 are typically arranged so that a single grid cell 14 is supported by four upright members 3 to form a single storage column 10 for the storage of one or more storage containers 9 in a stack. The transverse cross-section in the horizontal plane as shown in FIG. 2 shows that an individual storage column 10 is made up of four upright members 3 arranged at the corners of the storage container 9. A storage column 10 corresponds to a single grid cell. The cross section of the upright member 3 is constant over the whole length of the upright member. The periphery of a storage container in the horizontal plane in FIG. 2 shows the storage container having four corners and the arrangement of four upright members 3 at the corners of the storage containers within the storage column 10. A corner section of each of the four upright members, one from each of the four upright members, ensure that a storage container stored in the storage column 10 is guided into a correct position relative to any container stored within the storage column and the stacks of storage containers in the surrounding storage columns. A load handling device operative (not shown) on the track system 10 is able to lift a storage container as it is guided along the upright members 3 through a grid cell 14.

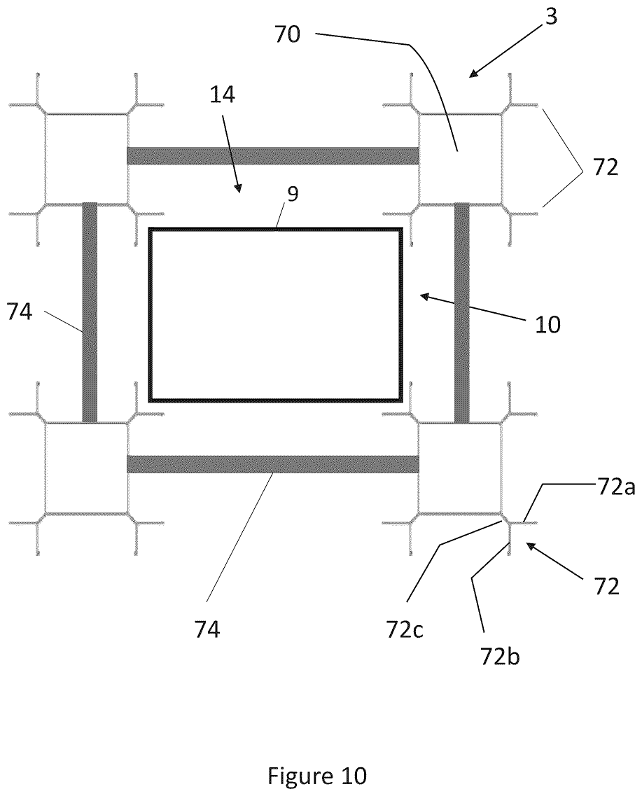

Each of the upright members 3 is generally tubular. In detail as shown in FIG. 2 and FIG. 10, each of the upright members 3 comprises a hollow centre section 70 (typically a box section) with one or more guides 72 mounted to or formed at the corners of the hollow centre section 70 that extends along the longitudinal length of the upright member 3 for guiding the movement of the storage containers along the storage column 10. The one or more guides 72 comprise two perpendicular container guiding plates. The two perpendicular container guiding plates are arranged to accommodate a corner of a storage container or a corner of a stack of storage containers. In other words, each of the corners of the hollow centre section 70 defines two sides of a substantially triangular area which may accommodate a corner of a storage container. The corners are evenly arranged around the hollow centre section 70 such that multiple upright members 3 may provide multiple adjacent storage columns, wherein each upright member 16 may be common or shared for up to four separate storage columns.

FIG. 10 shows a cross-sectional top view of the upright members 3 arranged within the grid framework structure to provide storage columns 10 for storage containers 9 in a stack to be guided along the upright members 3 and through a grid cell 14. The spacing between the upright members is sized to accommodate one or more storage containers 9 which are generally rectangular in a stack. Each of the upright members is generally tubular. In transverse cross-section in the horizontal plane of the storage column 10, each of the upright members 3 comprises a hollow centre section 70 with one or more guides 72 mounted to or formed to at least one wall of the upright member 3 that extends along the longitudinal length of the upright member 3 for guiding the movement of the storage containers. The hollow centre section 70 of the upright members contributes to the low weight of the grid framework structure. In the particular embodiment shown in FIG. 10, the hollow centre section 70 of the upright member is a box section. To at least one corner of the box section is mounted or formed a guide or corner section 72. However, there is no restriction to the cross-sectional shape of the hollow centre section of the upright member being a box section. Other shaped cross-sectional sections, such as circular, triangular, etc. are applicable.

The upright members 3 are spaced apart as shown in FIG. 10 so that the guides 72 mounted to the corners of different box sections cooperate with each other to provide a single storage column 10 for guiding the movement of storage containers vertically in a stack along the upright members. Depending on the position of the upright members 3 in the grid framework structure, guides 72 are mounted to one or all four corners of the box section of the upright members3. For example, when forming part of an exterior wall-shaped framework of the grid framework structure only one or two of the corners of the hollow centre section can comprise a guide or corner section 72 so as to cooperate with one or two corners of a storage container in a stack. In the case, where the upright member 3 is positioned within the interior of the grid framework structure, all four corners of the box centre section comprises a guide or corner section 72, each of the upright members 3 are arranged for cooperating with the corners of four storage containers 9.

In the particular example, each of the guides 72 is shown as V-shaped or has a 90° cross-sectional profile that is shaped to butt up against or accommodate the profile of the corners of the storage containers, which are generally rectangular in shape. As shown in FIG. 10, the guides comprises two perpendicular plates 72a, 72b (two container guiding plates perpendicular to each other) that extend longitudinally along the length of the upright member 3. An additional plate 72c shown in FIG. 10 extending along the length of the upright member is used to join the V-shaped guide at the apex of the V-shaped guide to the corner of the hollow centre section 70. The additional plate 72c is used to space the V-shaped guide away from the corner of the hollow centre section 70 so that the guide 72 including the spacer 72c has an overall Y-shaped cross-sectional profile.

The upright members 3 can be formed as a single body, e.g. by means of extrusion. Different materials can be used to fabricate the upright members including but are not limited to metals, e.g. aluminium, steel or even composite materials that have sufficient structural rigidity to support the grid and the load bearing devices traveling on the grid structure.

In the example illustrated in FIG. 10, the guides 72 are integral with the upright members 3. In other examples, as will be described below, the guides are separate members that can be attached to the upright members or to the horizontal members or to other grid components.

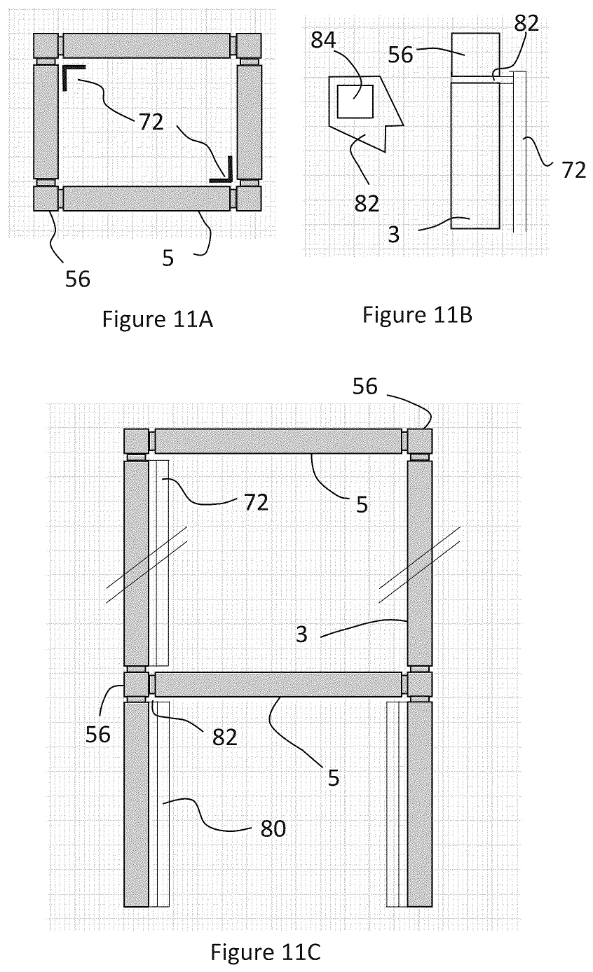

In the example illustrated in FIGS. 11 to 13, the grid framework structure is constructed by connecting horizontal and upright members together with connecting blocks or connectors 56.

An advantage of using the connectors to secure the guides is that one part is being used for two purposes: the connectors connect the horizontal members and upright members, and also support the guides. FIG. 11, views (a)-(c) illustrate one possible arrangement of separate guides provided at the corners of the storage columns, to help guide the movement of storage containers while being lifted or lowered by a load handling device on top of the track system.

FIG. 11, view (a), is a top view of a grid cell. The space inside the grid cell is a storage column, for storing a stack of storage containers. Four horizontal members 5, 7 are connected in a rectangular configuration by four connectors 56 to form the grid cell. Two guides 72 are positioned in the grid cell, at diagonally opposite corners of the grid cell. In some examples, guides 72 may be provided at one, two, three, or all four corners of the grid cell. Guides 72 at diagonally opposite corners of the grid cell have the advantage of providing enough stability and support to guide the storage container, while still using less material and fewer parts than guides at every corner of the grid cell. The guides 72 comprise two perpendicular elongated plates, extending in the vertical direction.

FIG. 11, view (b), schematically illustrates a side view of the guide 72 attached to an upright member 3. The guide 72 is connected to the upright member 3 by means of a guide support 82—also shown from the side view in FIG. 11, view (c). In the illustrated example the guide support 82 takes the form of a flat plate, but the guide support can take any suitable shape. The guide support 82 has an opening or eyelet 84 with a square shape, sized to co-operate with the connector portions of the connectors 56. The connector portion of the connector 56 fits through the opening 84 in the guide support 82. The connector portion of the connector is then inserted into the bore of the upright member 3, so the guide support 82 is secured between the connector 56 and the top end of the upright member 3. Similarly, the bottom end of the guide is connected to the bottom end of the same upright member 3 by means of a second guide support 82.

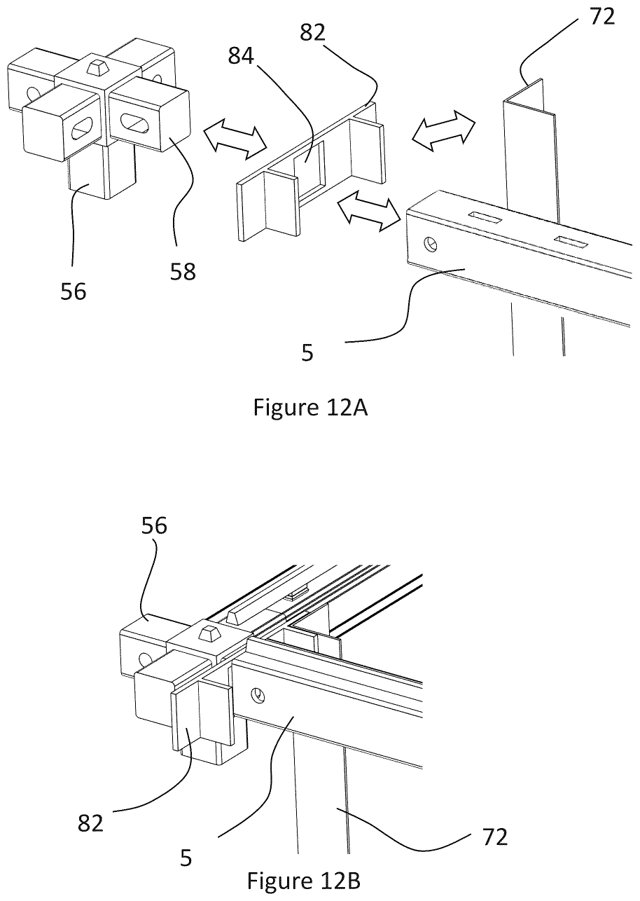

FIG. 12, in views (a)-(b), illustrates a guide support 82 for connecting two guides 72 to a connector 56, in exploded view (a), and assembled view (b). The guide support 82 comprises a square opening 84. In this example the opening 84 is square in order to co-operate with the square exterior cross section of the horizontal member 5; in other examples where the horizontal members have a different exterior cross section, a different shaped opening 84 can be used. When assembled in a grid framework structure 1, a connector portion 58 of the connector 56 passes through the opening 84 and inside the horizontal member 5, securing the guide support 82 between the connector 56 and the horizontal member 5. In this example the guide support 82 takes the form of a rectangular plate with two smaller plates protruding in a perpendicular direction. The rectangular plate and the smaller plates provide a right-angled bracket at each side of the guide support, where a guide can be connected. Any suitable attachment means can be used to attach the guide to the right-angled brackets, for example bolts or screws. The bottom ends of the guides 72 are connected to another connector 56 by means of another guide support 82 in a similar manner.

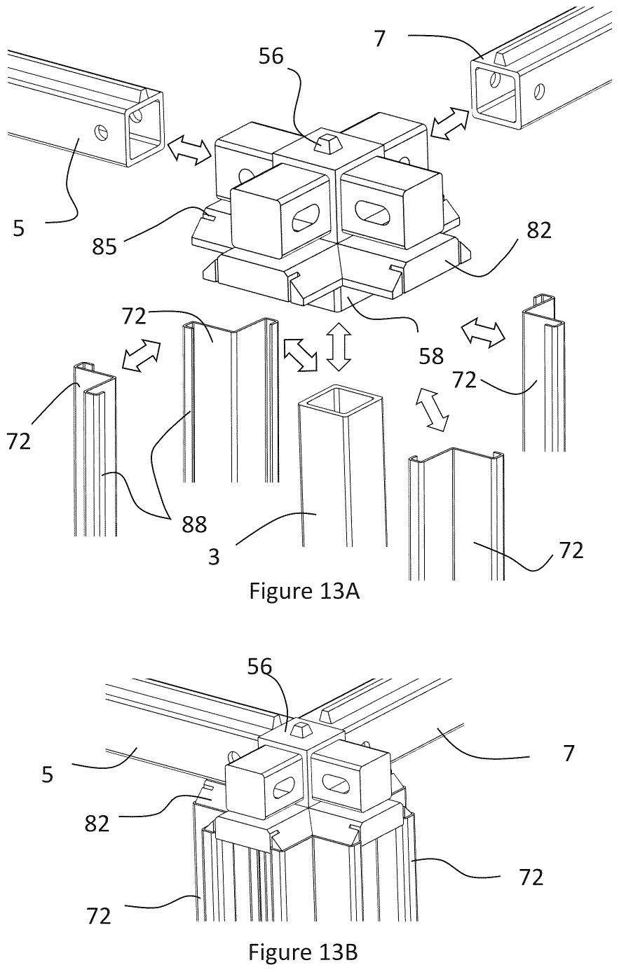

FIG. 13, in views (a)-(b), illustrates a guide support 82 for connecting four guides 72 to a connector 56, in exploded view (a), and assembled view (b). The guide support 82 can be either integral with the connector 56 (as shown), or can be a separate part. In the case where the guide support 82 is a separate part, the guide support comprises an opening 84 which co-operates with a connector portion 58 of the connector 56, so the connector portion 58 of the connector 56 can be inserted into the opening 84 of the guide support 82 in order to assemble the two parts together. The guide support 82 comprises eight slots 85, for connecting the guides 72. As in the previous examples, the guides 72 comprise two perpendicular elongated plates, extending in the vertical direction. In this example the perpendicular plates of the guides 72 are bent round at the edges to form a pair of lips 88, which also extend along the length of the guides 72.

To assemble the guides 72 to the connector 56, the lips 88 of the guides 72 are inserted into the slots 85. The horizontal members 5, 7 and the upright member 3 are assembled to the connector 56 by inserting the connector portions 58 of the connector 56 into the bores of the horizontal members 5, 7 and upright member 3. In the case where the guide support 82 is a separate part rather than integral with the connector, the connector portion 58 of the connector 56 is inserted into the opening 84 of the guide support 82 in order to assemble the two parts together. The bottom ends of the guides 72 are connected to another connector 56 by means of another guide support 82 in a similar manner.

In examples where the grid framework structure 1 is taller than a single upright member 3, i.e. where several upright members 3 are connected together to form an upright member to support the track system 13, several guides 72 can be used end-to-end along the upright member, rather than one long guide extending all the way from the ground to the track system at the top of the grid framework structure 1. Again, this arrangement has the advantage that the individual guides can be shorter, so are easier to manufacture, store, transport, handle, and assemble.

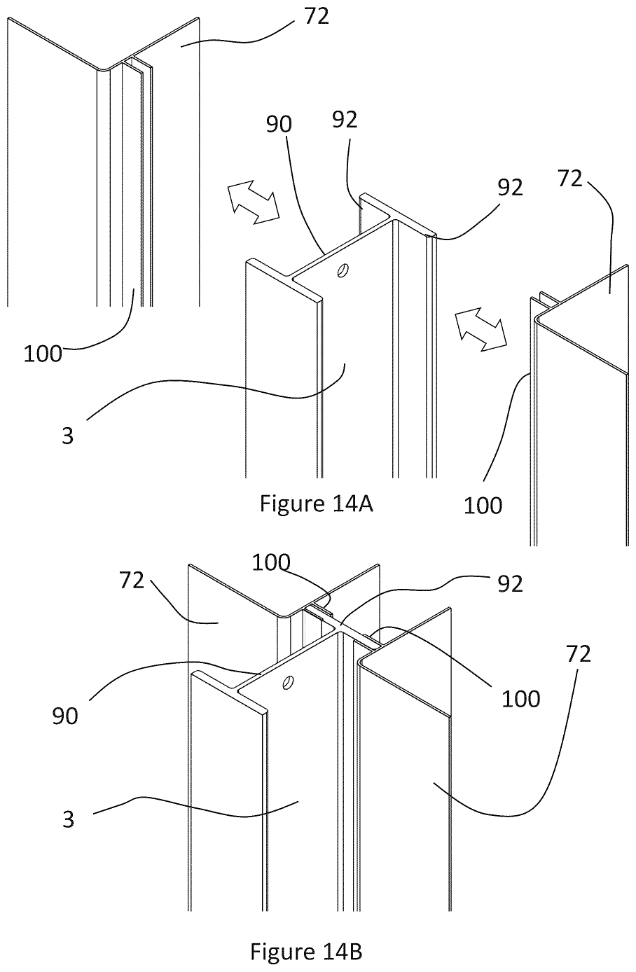

FIG. 14, in views (a)-(b), schematically illustrates another arrangement of guides in exploded view (a) and assembled view (b), suitable for cases where the upright members 3 are I-beams. In this example the guide connector is a pair of attachment plates 100 integrated with the guides 72. The pair of attachment plates 100 fit on either side of the edges of the flange 92 of the I-beam upright member 3. The upright member 3 can support four guides 72, one on either edge of each of the two flanges 92. Other suitable attachment means can be used in place of the two attachment plates 100.

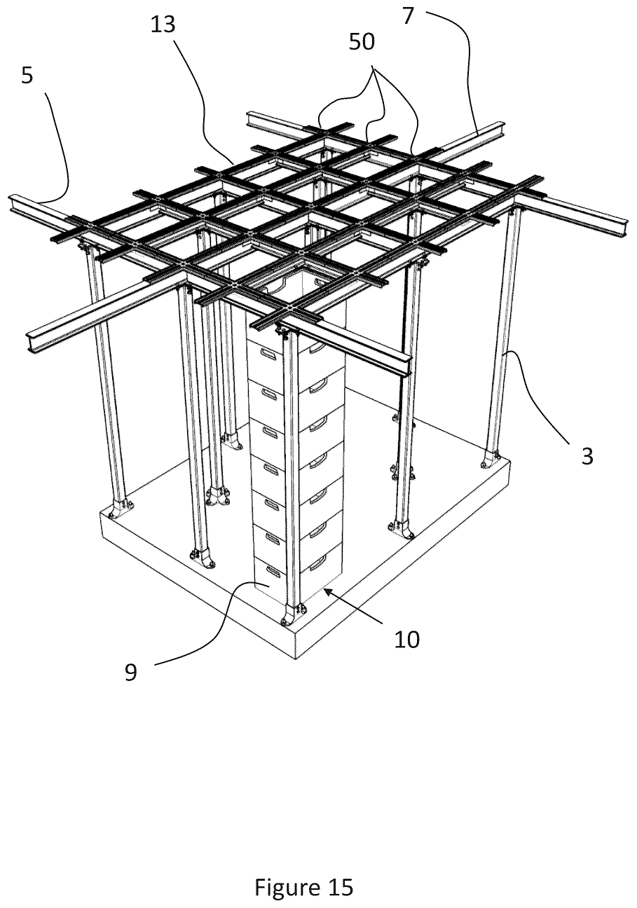

In comparison to the prior art, where an individual storage column comprises a group of four upright members arranged in a grid like pattern as shown in FIG. 9, in the particular example shown in FIG. 15 an individual storage column 10 comprises two upright members 3 that are arranged in a pattern such that diagonally opposing corners or edges of a storage container are accommodated by only two upright members 3. Thus, where in the prior art each of the four upright members of a given storage column is shared with a neighbouring storage column, in this example only two upright members 3 are shared with a neighbouring storage column. A single stack 11 of storage containers 9 is shown in FIG. 15. Reducing the number of upright members 3 whilst still having the ability to guide a storage container to the correct position through a grid cell by guiding the storage container only along diagonally opposing corners or edges reduces the time and cost to erect the grid framework structure. Moreover, the track system 13 would only need to be supported at alternative nodes or intersections 50 in the X and Y direction rather than at every node or intersection. The arrangement of the stacks of storage containers below the grid structure stays the same but they are only guided along two edges or corners of the storage containers. It is clearly apparent in the grid framework structure shown in FIG. 15 that not all of the nodes or intersections of the grid members are supported by an upright member 3. Using the terminology of the directions of the grid members discussed above with reference to FIG. 1, alternate nodes or intersections of the horizontal grid members 5 in the first direction are supported by an upright member 3.

Equally, alternate nodes or intersections of the horizontal grid members 7 in the second direction are supported by an upright member 3. The first direction and the second direction could represent the X and Y direction of the grid framework structure. The guides are not shown in FIG. 15 for clarity, but as discussed above could be either integral with the upright members 3 or separate parts attached to the upright members 3.

The above examples described with reference to FIGS. 10 to 15 are non-limiting examples of arrangements of guides 72. Other arrangements are also applicable.

### Grid Levelling

In some examples, the upright members 3 and guides 72 can be supported by anchor feet on the ground or floor at the base of the upright members. The feet can be adjustable, in order to control the height of the upright members and ensure that the track system is level. The anchor feet can also support the bottom end of the guides 72.

In other examples, levelling mechanisms can be installed at the top of the upright members. WO2022/034189 discloses an adjustable grid levelling mechanism for adjusting the level of a track system of a grid framework structure by adjusting a vertical distance between the at least one upright member and the track system.

Measuring Unit with Distance Sensors

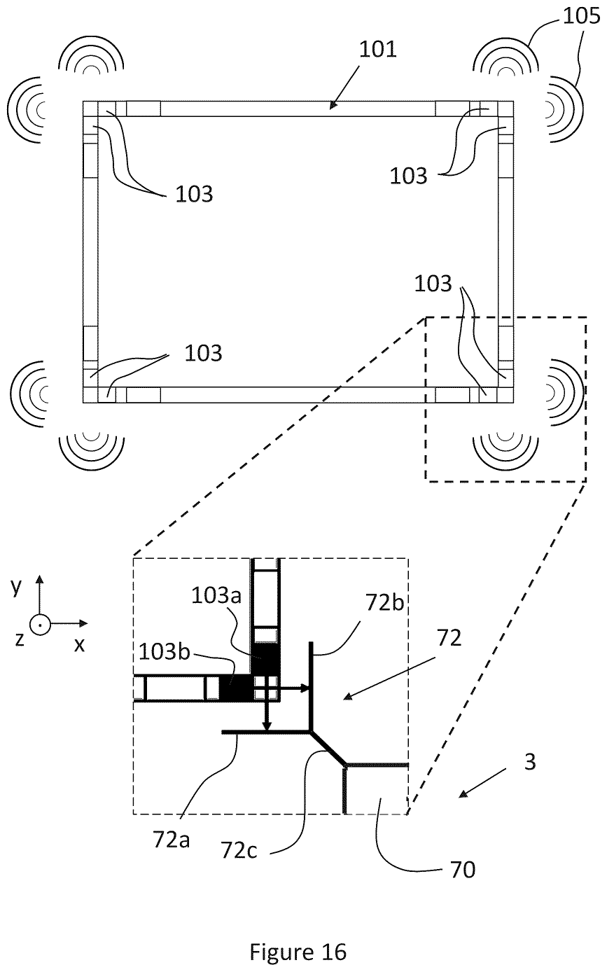

FIG. 16 schematically illustrates a top view of a measuring unit 101. The measuring unit 101 has a rectangular footprint, sized to fit inside a grid cell in order to be raised and lowered within a storage column by a load handling device. In this example the measuring unit 101 is provided with eight distance sensors 103. Two sensors are located on each of the four sides of the measuring unit 101, positioned towards the corners of the measuring unit 101.

The first direction (x direction) and the second direction (y direction) are indicated by axes on FIG. 16. The x and y directions are both substantially horizontal, with the z direction extending substantially vertically. The distance sensors 103 are directed along the sides and towards the corners of the measuring unit 101. Four of the distance sensors are directed in the x direction, and four in the y direction. A schematic representation of the working range 105 of the distance sensors 103 is also shown on FIG. 16, indicating the range in which the distance sensors can detect the presence of an object.

The inset of FIG. 16 illustrates a guide 72 comprising two perpendicular guiding plates 72a, 72b extending in the vertical direction. In this example the guide 72 is of the type illustrated in FIG. 10, where an upright member 3 comprises a hollow center section 70, four spacers 72c (only one shown), each connecting a pair of perpendicular plates 72a, 72b to the hollow center section 70. The upright member 3, as well as supporting the track system, provides guides 72 for all four of the adjacent storage columns. For clarity, the directions of distance sensors 103a, 103b are illustrated as arrows directed towards the perpendicular plates 72a, 72b respectively. The distance sensor 103a is directed in the negative y direction, substantially perpendicular to the plate 72a which extends horizontally in the x direction as well as vertically (i.e., in the x-z plane). The sensor 103b is directed in the x direction, substantially perpendicular to the plate 72b which extends horizontally in the y direction as well as vertically (i.e., in the y-z plane). The plates 72a, 72b of the guide 72 are within the working ranges 105 (not shown in the inset for clarity) of the distance sensors 103a, 103b, so the distance sensors can detect the presence of the plates 72a, b, and measure the distance between the distance sensors 103a, 103b and the plates 72a, 72b respectively.

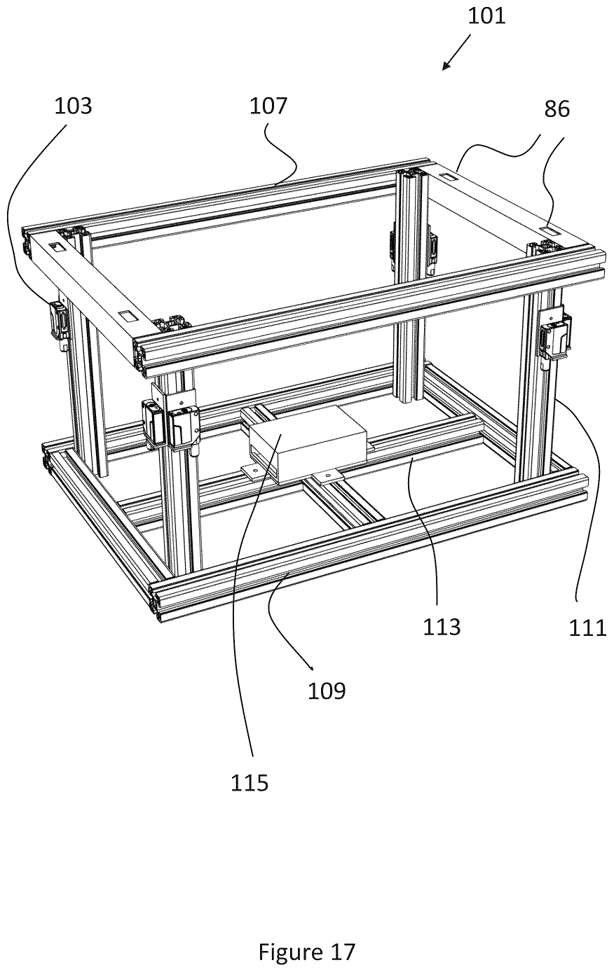

FIG. 17 is a schematic perspective view of a measuring unit 101, provided with eight distance sensors 103. The measuring unit comprises a 3D frame comprising an upper rectangular frame 107, a lower rectangular frame 109, and four vertical frame members 111 connecting the upper rectangular frame 107 and the lower rectangular frame 109. The four vertical frame members 111 are each positioned at a corner of the upper and lower rectangular frames 107, 109. The lower rectangular frame 109 is braced by a cross-brace 113 in order to ensure that the measuring unit is sufficiently rigid and reduces any deviation from squareness.

The upper rectangular frame 107 at the top of the measuring unit 101 and the lower rectangular frame 109 at the bottom of the measuring unit 101 both have the same footprint as a storage container 9. This ensures that the motion of the measuring unit 101 is smooth when being lowered or lifted in a storage column 10 by a load handling device 31. The outer edges of the corners of the upper rectangular frame 107 and the lower rectangular frame 109 will be in contact with and guided by the guides 72 while the measuring unit is being lifted or lowered.

As can be seen from FIG. 17, the vertical frame members 111 are positioned inside the upper and lower rectangular frames 107, 109. Eight distance sensors 103 are mounted on the vertical frame members 111, with two distance sensors 103 on each of the four vertical frame members 111. The positioning of the vertical frame members 111 on the inside of the rectangular frame 107, 109 ensures that there is a gap between the distance sensors and the guides.

In this example the distance sensors are ultrasonic sensors, which can measure short distances (for example, 20-100 mm). The distance sensors have a “dead zone” (for example, 20 mm), where a measurement cannot be taken. The limiting factor on the distance that a distance sensor can measure is how much of the signal can bounce back and be received by the detector, since the beam “spreads out” so not all of the signal is received by the detector. The limiting factor on the distance that a distance sensor can measure is how much of the signal is reflected from the object and returns to the detector. This is particularly relevant for ultrasonic sensors, since the ultrasonic beam spreads out more than some other kinds of distance sensor. The position of the distance sensors 103 such that they are spaced apart from the guides allows for the “dead zone” of the distance sensors and ensures that the guides 72 will be positioned within the working range 105 of the distance sensors 103 when the measuring unit 101 is located within a storage column 10.

As an alternative to ultrasonic sensors, the distance sensors could be laser sensors. Lasers tend to have a longer distance range than ultrasonic sensors, because the beam is less dispersed. The limiting factor on distance is how much of the signal gets back to the detector. In other examples, rather than eight short-range distance sensors positioned on the outside of the measuring unit, wide-angle laser sensors could be used. For example, two wide-angle laser sensors could be positioned back-to-back and located at or near the center of the measuring unit, with each of the two wide-angle laser sensors covering an angle of 180 degrees (hemisphere) so that the distance to the nearest obstacle can be measured in any direction.

In this example the distance sensors 103 are all at the same vertical position on the vertical frame members 111. In other examples, the distance sensors 103 may be vertically offset in order to reduce the risk of the signal from one distance sensor 103 being detected by the other distance sensor 103 on the same vertical frame member 111.

In other examples, the measuring unit 101 could be provided with a single distance sensor which is able to rotate in order to measure the distance to each of the set of guides. The single distance sensor can be positioned at or near the center of the measuring unit. The vertical frame members may need to be repositioned such that the sensor has a clear line of sight to each of the set of guides.

The cross brace 113 of the lower rectangular frame 109 supports a box 115. The box can be used to house any necessary electronic components.

A power source (e.g. a battery) can be provided in the measuring unit 101, or alternatively the measuring unit may be configured to receive power from the load handling device. In the latter case, the container-engaging assembly 43 is configured to receive power from the load handling device, for example by a flat flexible cable (FFC). The container-engaging assembly can transfer power to the measuring unit by means of the engaging means 42 (e.g. gripper elements 83) forming an electrical connection with the upper rectangular frame 107 of the measuring unit 101. In this case, the container-engaging assembly 43 may be provided with a locking mechanism to ensure that the container-engaging assembly remains engaged with the measuring unit 101 while in use. Alternatively, a separate power connector can be used.

In some examples, data from the distance sensors can be stored in a data logger (for example, a raspberry pi) located in the measuring unit 101. In other examples, data can be transferred from the measuring unit to the load handling device by any appropriate means, for example via a combined power and data cable, a separate data cable, or by wireless transfer.

The data from the distance sensors can be captured and stored by a data logger, and either processed by a processor located on the measuring unit, or processed later once the data has been removed from the measuring unit. In some examples, data from the data logger can be transferred via a CAN bus on the load handling device, to allow automated data capture and storage. Live analysis of the data can be carried out and results displayed, for example via a web application.

The form of the measuring unit illustrated in FIG. 17 is just one example of how a measuring unit can be implemented, and is not intended to be limiting. In other examples, the measuring unit 101 could be a modified storage container 9, or have a single rectangular frame rather than the two rectangular frames, or can take any other suitable form. The important features of the measuring unit 101 are that it can be engaged by the container-engaging assembly 43 of a load handing device 31, can be guided by the guides 72, and can support one or more distance sensors 103. In other examples, the measuring unit 101 may be a modified container-engaging assembly 43, rather than a separate unit that is engaged by the container-engaging assembly 43.

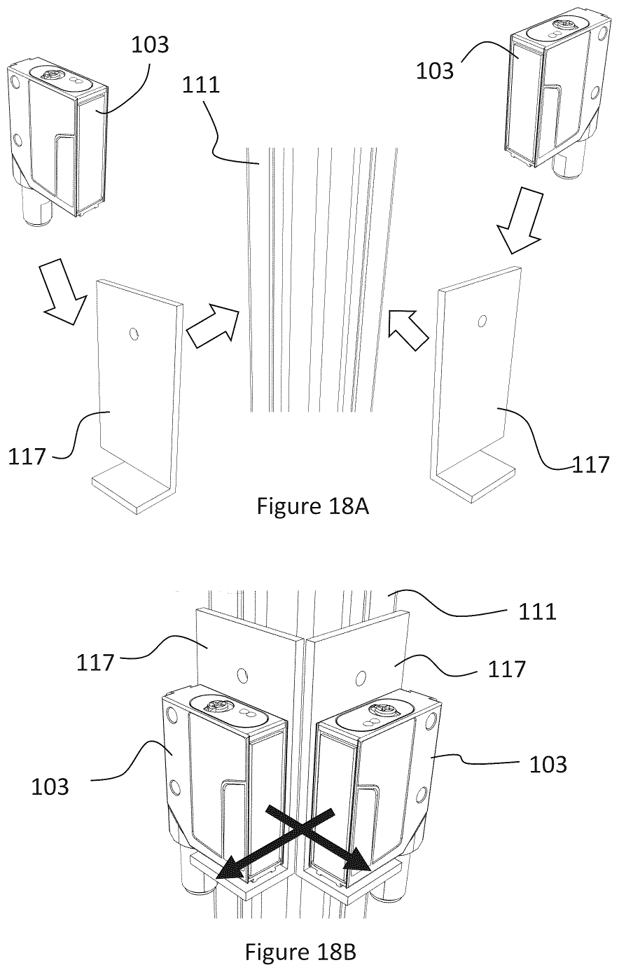

FIG. 18, views (a)-(b), show schematic perspective views of two distance sensors 103 mounted to a vertical frame member 111 of a measuring unit. Each distance sensor 103 is supported by a bracket 117. The brackets 117 are attached to the vertical frame member 111. FIG. 18, view (a), shows the two distance sensors 103, their respective brackets 117, and the vertical frame member 111, and FIG. 18, view (b), illustrates the same components in assembled position. The black arrows on FIG. 18, view (b), indicate the respective direction of measurement of the distance sensors 103. The distance sensors 103 are directed parallel to the sides of the measuring unit. In the illustrated example the beams from the two distance sensors 103 cross, but in other examples the distance sensors 103 may be vertically offset in order to reduce the risk that a signal from one distance sensor 103 is picked up by the other distance sensor 103, which could give a false reading for the measured distance between the sensor and a guide.

In an alternative embodiment, the measuring device may be provided with a single distance sensor which can change its direction in order to measure the distance between the sensor and an object in any direction. In this example, a single sensor can measure the distance to all of the guides in the set of guides in a storage column.

### Other Sensors

As well as measuring the horizontal distance between the distance sensors and the guides, in some examples the measuring unit can be provided with z distance sensors to measure the vertical distance between the z distance sensors and the floor and/or the underside of the load handling device. The z distance sensors measure distance in the z direction (the vertical direction), as illustrated by the axes on FIG. 1 and FIG. 18. This distance measurement allows the height of the measuring unit to be determined.

The measuring unit can be provided with an upwardly-directed vertical distance sensor mounted to the measuring unit and directed vertically upwards. The beam from the z distance sensor rebounds from the underside of the load handling device which is carrying the measuring unit, and is reflected back downwards to be detected by the vertical distance sensor. The underside of the load handling device may be provided with a reflective plate to facilitate the reflection of the beam from the vertical distance sensor.

Alternatively, or additionally, the measuring unit can be provided with a downwardly-directed vertical distance sensor mounted to the measuring unit and directed vertically downwards. The beam from the vertical distance sensor rebounds from the floor at the bottom of the storage column (or from a storage container stored within the storage column), and is reflected back upwards to be detected by the vertical distance sensor. The measuring unit can be provided with both an upwardly-directed vertical distance sensor and a downwardly-directed vertical distance sensor, or only one, or neither.

The vertical distance sensors may be ultrasonic sensors or laser sensors. Laser sensors tend to be better suited to longer ranges than ultrasonic sensors, because the beam is less dispersed. The limiting factor on distance is how much of the signal gets back to the detector. Some of the beam will be absorbed by the surface that the beam hits (the underside of the load handling device or the floor), so, in some examples, reflectors can be placed at the positions where the beam will strike.

The measuring unit may further comprise one or more tilt sensors to detect whether the measuring unit is level. Two tilt sensors may be provided, one to measure tilt in the x direction, and one to measure tilt in the y direction. Any tilt of the measuring unit can be taken into account when determining misalignment.

In some examples the measuring unit may comprise a camera directed downwards towards the bottom of the storage column. Photographs and/or video can be recorded while the measuring unit is being lifted or lowered between the guides in the storage column. In some examples, video can be transmitted via a live video field to a human operator, who can check the video and highlight any obvious issues with misalignment or items stuck in the storage column. Alternatively, the video or photos can be checked only if a problem with misalignment is identified from the measurements taken with the distance sensors of the measuring unit. If the measuring unit gets stuck or hits an obstacle, video or photos may be useful to determine the cause of the problem and understand what actions are needed.

The measuring unit may further comprise one or more vibration sensors for measuring vibrations of the grid framework structure. Fatigue affects the lifetime of components of the grid framework structure, and vibration measurements can help to understand the life of components of the grid framework structure and allow predictive maintenance to repair or replace parts before they fail. The one or more vibration sensors can be used to detect changes in stiffness in the grid framework structure; for example if a natural frequency changes, that may be an indication that a part is broken.

The one or more vibration sensors can measure a frequency spectrum of vibrations in the grid framework structure. A baseline frequency spectrum of the grid framework structure can be measured, for example after the grid framework structure is first installed, and the frequency spectrum measured at a later date can be compared to the baseline frequency spectrum in order to identify any deviations from the baseline, which may be indicative of changes or problems in the grid framework structure.

Vibrations can be measured either while the grid framework structure is operational, or during maintenance periods where operation on the grid framework structure is paused. The former gives the opportunity to detect issues with load handling devices, whereas the latter is preferable for monitoring the status of the grid framework structure. If the load handling device that is lifting/lowering the measuring unit has a problem, for example an unbalanced motor, this issue can be detected. If measurements are taken while the grid framework structure is operational, vibrations from other load handling devices running on the track system can also be measured, and any anomalies in the vibrations can be used to detect potential issues.

Furthermore, if one of the set of guides is damaged at a particular vertical location, the measuring unit may experience a bump or jolt and deviate from its path when being lifted or lowered through that vertical location. This can be used to determine the vertical position of any faults or local damage to the set of guides.

The vibration sensors may be triaxial vibration sensors, which enable the measuring unit to determine which direction vibrations are coming from. If multiple measuring units with vibration sensors are used on the same grid framework structure, the signals can be triangulated to pinpoint the source of the vibration with greater precision. Alternatively, a “vibration map” of the grid framework structure can be determined in a similar way to the misalignment map, and used to determine whether there are specific locations in the grid framework structure that are sources of unusual vibrations which need further investigation.

### Calibration

Before taking any measurements, several calibration steps can be undertaken. The measuring unit can be checked for squareness, the load handling device can be calibrated, and the grid cell can be checked for squareness.

The measuring unit can be checked for squareness by, for example, measuring the distances between the members of the upper and lower rectangular frames, checking that the members are perpendicular, measuring the distance between the upper and lower frames at different points, and checking that the vertical frame members of the measuring unit are perpendicular to the upper and lower rectangular frames. The measurements can be taken manually or by using a measurement jig.

Before taking any measurements with the measuring unit, the load handling device can be calibrated so that the measuring unit will have consistent offsets when measuring distances.

The load handling device can be calibrated by using a reference surface as a “zero point” for each distance to be measured in the storage column, so that each distance to be measured has a reference measurement. The load handling device can be placed on a calibration jig (known to be square/rectilinear) comprising a single grid cell and storage column with a set of guides (known to be aligned). The guides on the calibration jig can be used as the reference surfaces in order to acquire reference measurements to use as a point of comparison for each distance to be measured in the storage columns of the grid framework structure.

The grid cells of the grid framework structure can be checked by using the distance sensors on the measuring unit to measure the distances to the edges of the horizontal members forming the top of grid cell, with the measuring unit raised to a position such that the distance sensors are at the same height as the top of the grid cell.

### Misalignment

The raw data from the distance sensors can be compared with the reference measurements taken during the calibration process to calculate a misalignment value. For example, a reference measurement (distance between a given distance sensor and a surface of a guide on the calibration rig) can be subtracted from the actual measurement to give a misalignment value. For example, if an actual measurement taken by a distance sensor on the measuring unit in a storage column is 11 mm, and the corresponding reference measurement taken on the calibration rig is 10 mm, the misalignment value will be 11 mm-10 mm=1 mm.

The misalignment value determined from the measurements can be compared to a predetermined threshold misalignment value. For example, if the predetermined threshold misalignment value is 1 mm, any misalignment below 1 mm is considered to be within acceptable limits, and any misalignment value at or above 1 mm is considered to be misaligned. In the example above, with an actual measurement of 11 mm the misalignment value of 1 mm is at the predetermined threshold misalignment value of 1 mm, so is considered to be misaligned. If the actual distance measured by the same distance sensor were 10.5 mm, the misalignment value would be 10.5 mm-10 mm=0.5 mm, which is below the predetermined threshold misalignment value of 1 mm so would not be considered to be misaligned.

Alternatively, misalignment can be determined by the effective size of the grid cell as measured by the distance sensors on the measuring unit. For example, the measurements from two distance sensors in opposite directions can be added to the distance between the two sensors in order to calculate the total width of the storage column in one dimension. The width of the storage column here is defined and delineated by the guides. This total width can be compared to a reference width, and a misalignment value calculated as the difference between the two. An example is described below.

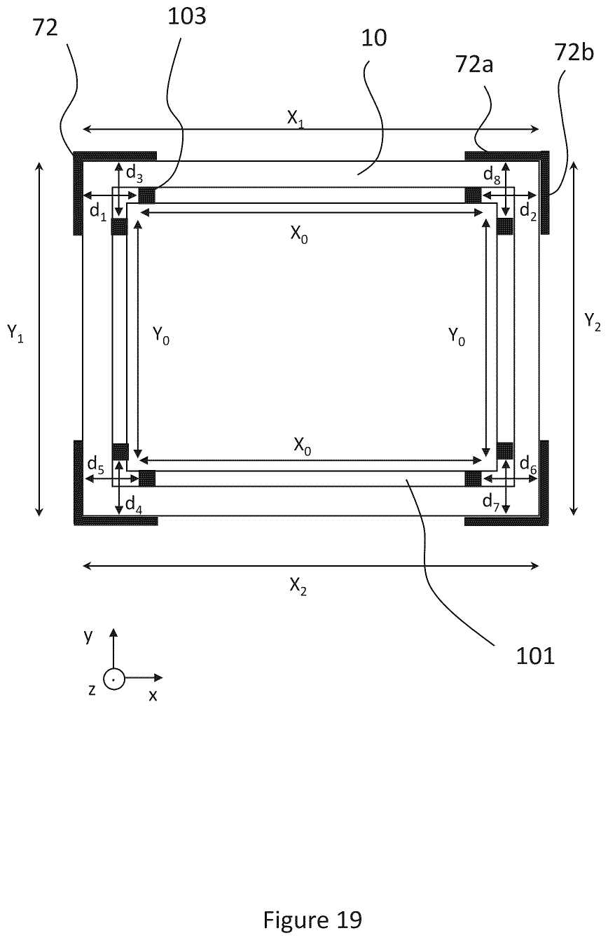

FIG. 19 schematically illustrates a top view of a measuring unit 101 with eight distance sensors 103, inside a storage column 10. A set of four guides 72 are located in the four corners of the storage column 10. Each of the four guides 72 has two perpendicular plates 72a, 72b. Each of the eight distance sensors 103 measures a distance (labelled d₁ to d₈ on FIG. 19) between the distance sensor and a respective perpendicular plate 72a, 72b of one of the set of guides 72. A total of eight distances are measured, four in the x direction and four in the y direction.

The measured distances d₁ to d₈ are used to calculate the total x and y dimensions of the storage column delineated by the guides. The distances X₀ and Y₀ are the distances between the two distance sensors 103 mounted on the same side of the measuring unit 101 in the x direction and in the y direction respectively. The measured distances d₁ to d₈ and the distances X₀ and Y₀ can be added together to calculate the lengths of the four sides of the measuring unit using the following equations:

X₁=d₁+X₀+d₂

Y₁=d₃+Y₀+d₄

X₂=d₅+X₀+d₆

Y₂=d₇+Y₀+d₈

The four side lengths X₁, X₂, Y₁, Y₂ can be compared to reference values of the four side lengths in order to calculate a misalignment value for each of the four side lengths. The reference values of the four side lengths can be measured in the calibration rig as described above. Again, the misalignment value can be compared to a predetermined threshold misalignment value, and the storage column deemed to be misaligned if the misalignment value exceeds the predetermined threshold misalignment value.

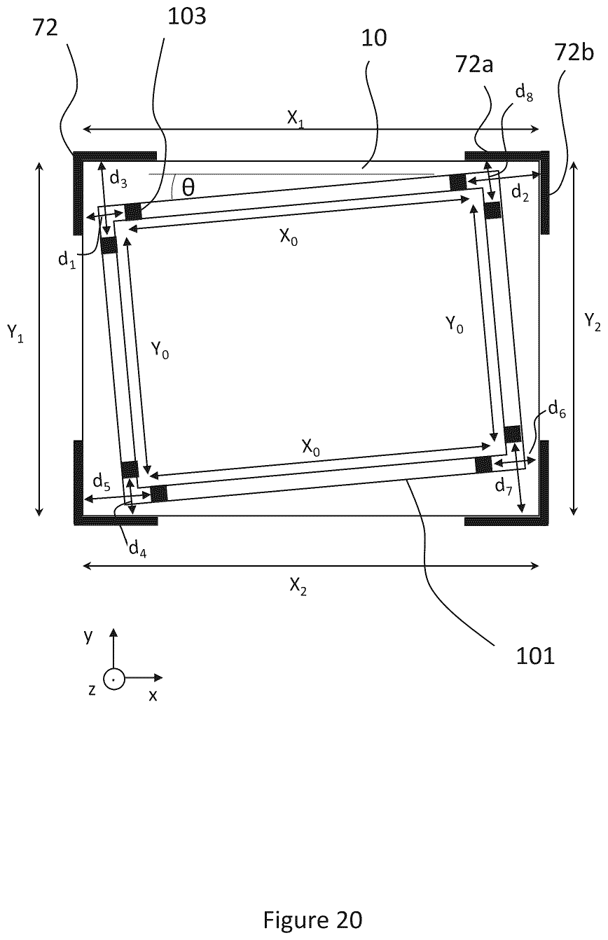

In other examples, other measures of misalignment can be used. For example the skew angle of the measuring unit inside the storage column can be calculated from the distances and compared to a predetermined threshold misalignment value for the skew angle. In FIG. 19, the measuring unit 101 is aligned such that the sides of the measuring unit 101 are parallel to the sides of the storage column. The measured distances between the two sensors directed towards the same side of the storage column are equal (i.e. d₁=d₅, d₂=d₆, d₃=d₈, d₄=d₇). If the measuring unit is skewed relative to the storage column, however, these distances will not be equal. FIG. 20 illustrates a measuring unit 101 which is skewed relative to the storage column 10. It can clearly be seen that the sides of the measuring unit 101 are not parallel to the sides of the storage column 10. The angle θ between the side X₁ of the storage column and the corresponding side of the measuring unit (shown in FIG. 20) can be calculated as follows:

sin θ=(d₃−d₈)/X₀

Similar calculations can be carried out for the other sides, and an average of the four angles can be taken to define a skew angle. The skew angle can be used as a misalignment value, and compared to a predetermined threshold misalignment value. For example, if the calculated skew angle is 5°, and the predetermined threshold misalignment value is 2°, the measurement unit will be deemed to be misaligned within the storage column. This kind of misalignment could happen if, for example, one or more of the set of guides has been laterally displaced so that the guides are farther apart and the measuring unit has space to turn within the storage column.

If the skew angle is too great, the angular misalignment between a storage container and the storage container below in the stack may cause issues with stacking, i.e., the storage container may not stack neatly on top of the storage container below. If misaligned guides cause a storage container to be stacked at a skewed angle rather than with its sides perpendicular to the storage column, this may cause a problem with retrieval of the storage container. When a load handling device attempts to retrieve the skewed storage container, the container-engaging assembly of the load handling device may fail to engage with the storage container so that retrieval is not possible.

In another example, if opposing side lengths are not substantially equal (e.g. if X₁ is not substantially equal to X₂, or if Y₁ is not substantially equal to Y₂), that may be an indication that one or more of the guides has been laterally displaced. For example, if the misalignment value X₁-X₂ is 5 mm, and the predetermined threshold misalignment value is 1 mm, the guides will be deemed to be misaligned.

In another example, the sides of the storage column as defined by the four side lengths X₁, X₂, Y₁, Y₂ may not be parallel, i.e. side X₁ may not be parallel to side X₂, and side Y₁ may not be parallel to side Y₂. Any angular deviation of the storage column sides from the x and y axes can be used as a misalignment value. Similarly, the angles between adjacent sides as defined by the four side lengths X₁, X₂, Y₁, Y₂ may not be perpendicular, and the deviation of the angles between adjacent sides from 90° can be used as a misalignment value. In another example, the measuring unit may not be exactly in the centre of the storage column. For example if the measuring unit 101 is towards the left of the storage column 10 rather than in the centre, distances d₁ and d₈ will be smaller than distances d₂ and d₆, and the differences (d₁−d₂) and (d₅−d₆) would be an appropriate misalignment value.

In another example, the measuring unit can be used to determine whether a guide deviates from the vertical. This would provide information on where repairs may be required or why certain locations are more troublesome when depositing/retrieving storage containers.

Misalignment of a guide from the vertical could be determined by calculating the distance between the set of guides, taking multiple measurements at different heights in the storage column. For example, this could be the side lengths X₁, X₂, Y₁, Y₂ in a storage column with a guide at each of the four corners, or the diagonal distance between two guides at diagonally opposing corners of a storage column. If the distance between two guides is observed to vary with height, this may be an indication that one of the two guides is inclined compared to the vertical. This could be verified by moving the measuring unit to a grid cell on the other side of one of the guides, with the expectation of seeing the reverse variation of the distance with height. The angle α between the guide and the vertical can be calculated as follows:

tan α=((distance measured at height H₁)−(distance measured at height H₂))/(H₁−H₂).

For example, if the misalignment value α of a given guide is 8° from the vertical, and the predetermined threshold misalignment value is 6°, the guide is considered to be misaligned.

It will be understood that the above ways of calculating misalignment are examples only. Other ways of measuring or calculating misalignment values can also be used.

### Method of Determining Alignment

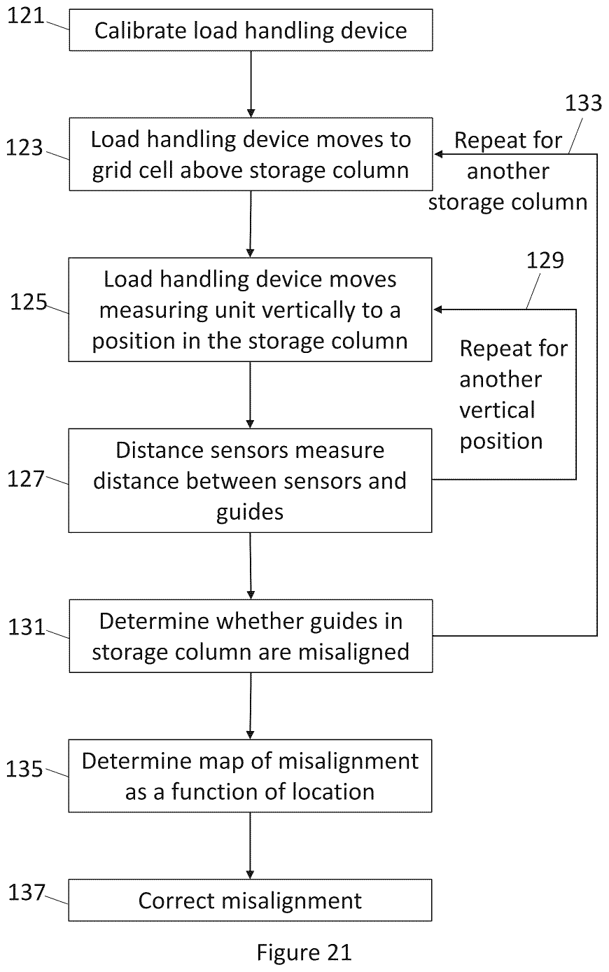

FIG. 21 is a flowchart which schematically illustrates a method of determining misalignment in a grid framework structure. In a step 121, the load handling device is calibrated, as described above. In a step 123, the load handling device moves to the grid cell above the storage column that is to be measured. In a step 125, the load handling device moves the measuring unit vertically to a position in the storage column. This may be by lowering the measuring unit down the storage column. In a step 127, the distance sensors mounted on the measuring unit measure the distance between the distance sensors and guides. As described above, one or more distance sensors can be used.

In a step 129, the step 125 of moving the measuring unit vertically to a position in the storage column and the step 127 of measuring the distance between the sensors and the guides is repeated for another vertical location. Step 129 can be carried out by the load handling device lowering the measuring unit from the top of the storage column to the bottom of the storage column, with the sensors continually measuring distance as the measuring unit descends. Alternatively or additionally, the load handling device can raise the measuring unit from the bottom of the storage column to the top of the storage column, with the sensors continually measuring distance as the measuring unit ascends. Alternatively or additionally, the load handling device can pause lifting or lowering and hold the measuring unit in a stationary position before a measurement is taken.

In a step 131, the method determines whether guides in storage column are misaligned. As discussed above, a misalignment value can be calculated from the measured distances and compared to a predetermined threshold misalignment value. The guides are deemed to be misaligned if the misalignment value exceeds the predetermined threshold misalignment value. The misalignment value can be measured as a function of vertical distance up the storage column, in order to determine whether a guide is misaligned along its full length, or only along a part of its length.

In a step 133, steps 123, 125, 127, and 129 are repeated for another storage column in the grid framework structure. Once the measuring unit has completed the measurements of the original storage column, the load handling device lifts the measuring unit up into the container-receiving space of the load handling device above the track system, and moves horizontally on the track system to a grid cell above another storage column (step 123). The load handling device then lowers the measuring unit to a vertical position in the new storage column (step 125), and the process of taking measurements and determining misalignment is repeated for the new storage column. In this way, misalignment of part or whole of the grid framework structure can be determined.

In a step 135, a map of misalignment can be created as a function of location in the grid framework structure. The map of misalignment can be used to store the misalignment values as a function of horizontal distance (position on the x and y axes, or row and column number) and height within the storage column (position on the z axis). The map can store measured distances, calculated misalignment values, and/or a Boolean indicating whether or not the misalignment value exceeds the predetermined threshold misalignment value. The map of misalignment can be used to indicate which areas of the grid framework structure have problems with misalignment, so that further investigation or remedial action can be taken to solve the problem.

In a step 137, any misalignment of the grid framework structure is corrected. The misalignment map will give an indication of the severity of the misalignment and the size of the affected area. In many cases a full disassembly of the relevant part of the grid framework structure may not be needed. For example, fastenings that connect guides to upright members and/or that connect upright members to horizontal members can be loosened. This permits some play in the positioning and alignment of the grid members, so small adjustments in position can be made and the fastenings then tightened to secure the grid components in their aligned positions.

1. A method of determining the alignment of a grid framework structure, the grid framework structure including i) a track system comprising a plurality of tracks arranged in a grid pattern, configured to support one or more load handling devices thereupon; ii) a supporting framework structure comprising a plurality of upright members for supporting the track system above the ground to create a plurality of storage columns for the storage of a plurality of storage containers in stacks such that a load handling devices operative on the track system is configured to lift a storage container through a grid cell from a stack below the track system; and iii) a plurality of guides, each comprising one or more substantially vertical surfaces for guiding storage containers in a storage column between the guides when lifted or lowered in a vertical direction; the method comprising the steps of:
a) a load handling device lifting or lowering a measuring unit within a storage column in a vertical direction between a set of the plurality of guides, such that the measuring unit is guided by the set of guides, the measuring unit comprising a distance sensor mounted to the measuring unit;
b) measuring the distance between the distance sensor and one guide of the set of guides;
c) determining whether the guide is misaligned based on the measured distance.

2. The method of claim 1, wherein lifting or lowering the measuring unit in step a) comprises the measuring unit being engaged by a container-engaging assembly of the load handling device.

3. The method of claim 1, further comprising the step of calibrating the load handling device before step a).

4. The method of claim 1, wherein the measuring unit comprises a plurality of distance sensors mounted to the measuring unit, and step b) comprises, for each of the plurality of distance sensors, measuring the distance between that distance sensor and a respective guide of the set of guides, and step c) comprises determining whether the set of guides are misaligned based on the plurality of measured distances.

5. The method of claim 1, wherein step b) comprises measuring a plurality of distances between the distance sensor and one or more guides of the set of guides, and step c) comprises determining whether the set of guides are misaligned based on the plurality of measured distances.

6. The method of claim 4, wherein step b) comprises, for each distance sensor, measuring a plurality of distances between the distance sensor and one or more guides of the set of guides, and step c) comprises determining whether the set of guides are misaligned based on the plurality of measured distances.

7. The method of claim 1, wherein step c) comprises determining a misalignment value from the measured distance(s), comparing the misalignment value to a predetermined threshold misalignment value, and determining that the guides are misaligned if the misalignment value is greater than the predetermined threshold misalignment value.

8. The method of claim 1, further comprising the step of:
d) repeating steps a) to c) for another storage column in the grid framework structure.

9. The method of claim 7, further comprising the steps of:
d) repeating steps a) to c) for another storage column in the grid framework structure; and
e) determining a map of the misalignment value as a function of location in the grid framework structure.

10. A measuring unit configured to be lifted and lowered by a load handling device, the measuring unit comprising at least one distance sensor mounted to the measuring unit configured to measure the distance(s) between the sensor and a vertical surface of a guide.

11. The measuring unit of claim 10, further comprising an outer casing configured to be received within the load handling device, wherein the outer casing comprises one or more engagement features configured to be engaged by the load handling device.

12. The measuring unit of claim 11, wherein the measuring unit is substantially cuboid in shape and comprises a base and four side walls, and wherein the at least one distance sensor comprises eight distance sensors, two of the eight distance sensors positioned on each of the four side walls of the measuring unit.

13. The measuring unit of claim 12, wherein the distance sensors are located near to the edges of the side walls and adjacent distance sensors are vertically offset.

14. The measuring unit of claim 12, wherein the at least one distance sensor comprises two wide-angle distance sensors positioned on diagonally opposing corners of the measuring unit.

15. The measuring unit of claim 10, further comprising a first vertical distance sensor directed vertically upwards in use, configured to measure the vertical distance between the first vertical distance sensor and the underside of the load handling device and/or a second vertical distance sensor directed vertically downwards in use, configured to measure the vertical distance between the second vertical distance sensor and the ground.

16. A load handling device for lifting storage containers stacked in a grid framework structure, the load handling device being configured to lift and lower a measuring unit according to claim 10.

17. The load handling device of claim 16, comprising a container-engaging assembly configured to engage with the measuring unit.

18. The load handling device of claim 16, comprising a container-engaging assembly, wherein the container-engaging assembly is the measuring unit.

19. A storage and retrieval system comprising:
a) a grid framework structure configured to support one or more load handling devices thereupon, the grid framework structure comprising:
i) a track system comprising a plurality of tracks arranged in a grid pattern, configured to support one or more load handling devices thereupon;
ii) a supporting framework structure comprising a plurality of upright members for supporting the track system above the ground to create a storage space for the storage of a plurality of storage containers in stacks such that, in use, a load handling devices operative on the track system is configured to lift a storage container through a grid cell from a stack below the track system;
iii) a plurality of guides, each of the plurality of guides comprising one or more vertical surfaces for guiding storage containers in a storage column between the upright members when lifted or lowered in a vertical direction;
b) one or more load handling devices; and
c) one or more measuring units.

20. The storage and retrieval system of claim 19, wherein each of the one or measuring units has substantially the same footprint as the storage containers.
